(19) United States
(12) Patent Application Publication
(10) Pub. No.: US 2007/0294116 A1
(43) Pub. Date: Dec. 20, 2007

(54) Method and system for an online rental vehicle reservation-booking website including a travel agent path

(76) Inventors: Scott Paul Stephens, St. Louis, MO (US); John A. Altermatt, Wildwood, MO (US); Ronald S. Cerko, St. Louis, MO (US); Paul C. Tucker, Ballwin, MO (US); Kelli J. Boruff, St. Charles, MO (US)

Correspondence Address: THOMPSON COBURN, LLP, ONE US BANK PLAZA, SUITE 3500, ST LOUIS, MO, 63101, US

(21) Appl. No.: 11/452,862

(22) Filed: Jun. 14, 2006

(51) Int. Cl. G06Q 10/00

(52) U.S. Cl. 705/5

(57) ABSTRACT

A system and method is disclosed herein for providing a travel agent path through a rental vehicle reservation-booking website. Among the features described as embodiments of the invention include the ability to quickly load travel agent client information into a renter information page of the website and the ability for travel agents to control their commission percentages. Also described is a confirmation page for the website having user-configurable features.

### CROSS-REFERENCE TO RELATED PATENT APPLICATIONS

The following pending patent applications are related to this disclosure: U.S. patent application Ser. No. 11/377,811, filed Mar. 16, 2006, entitled “Method and System for Providing and Administering Online Rental Vehicle Reservation Booking Services”, U.S. patent application Ser. No. 11/039,203, filed Jan. 20, 2005, entitled “Method and Apparatus for Improved Customer Direct On-Line Reservation of Rental Vehicles”, U.S. patent application Ser. No. 10/505,685, filed Aug. 25, 2004, entitled “Method and Apparatus for Customer Direct On-Line Reservation of Rental Vehicles Including Deep-Linking”, PCT patent application PCT/US03/18553, filed Jun. 13, 2003, entitled “Method and Apparatus for Customer Direct On-Line Reservation of Rental Vehicles Including Deep-Linking”, and U.S. patent application Ser. No. 10/172,481, filed Jun. 14, 2002, entitled “Method and Apparatus for Customer Direct On-Line Reservation of Rental Vehicles”, the entire disclosures of all of which are incorporated herein by reference.

### FIELD OF THE INVENTION

This invention generally relates to the field of providing a website that allows users to book rental vehicle reservations online.

### BACKGROUND AND SUMMARY OF THE INVENTION

Internet technology has transformed the manner in which rental vehicle service providers do business with their customers. However, due to the impersonal nature of the Internet, a need exists in the art for rental vehicle service providers to increasingly personalize and streamline their reservation booking websites to meet customers' varied needs and desires. This need exists not only in connection with a rental vehicle service provider's general retail customers but also its business partners, including business partners such as travel agents. As used herein, “travel agent” refers to not only individuals who book travel reservations on behalf of third parties perhaps for a commission, but also business entities employing one or more of such individuals. The term travel agent could thus include a typical commercial business which routinely advertises vacation packages such as cruises in the newspaper for example, but also captive or “in-house” employees who book the business travel of their co-workers. Such travel agents could have a recurring need to book a rental vehicle reservation with a rental vehicle service provider on behalf of a third party (the third party being the “client” of the travel agent).

The commonly-owned related patent applications referenced above provide various teachings as to how an improved rental vehicle reservation-booking website can be implemented, including disclosing various exemplary pages and paths through a rental vehicle reservation booking website. Among the pages described in these pending patent applications that can be used in the website of the preferred embodiment of the present invention include a Home (H) page, a Choose Vehicle Type (CV) page, a Choose Location (CL) page, a Renter Information (RI) page, a Verify (V) page, a Confirmation (C) page and others.

To streamline a user's path through the website, the patent applications referenced above describe a deep-linking concept that allows users to directly access a page of the website that would normally be reached after the user has accessed previous website pages to submit at least one other reservation characteristic. FIG. 2 illustrates this concept.

As used herein, “path” refers to the sequence of pages accessed by the user as he/she interacts with the website to create a rental vehicle reservation. For example, one path would be for the user to (1) first access a home page of the website, (2) in response to user submission of location and temporal information for the reservation through the home page, next access a page that requests the user to select a vehicle type for the reservation, (3) in response to user submission of a vehicle type for the reservation, next access a page that requests the user to enter renter information, (4) in response to user submission of the requested renter information, next access a page that requests the user to verify the submitted reservation characteristics to thereby book a reservation in accordance with those characteristics, and (5) in response to user submission of the requested verification, next access a page that confirms the booked reservation. Another path through the website would be for the user to skip step (3) by accessing a stored customer profile from which the user's renter information can be automatically loaded.

The inventors herein feel that a need exists in the art to provide travel agents with their own specialized path through a rental vehicle reservation-booking website, wherein this path is tailored to meet a travel agent's business needs.

In an effort to fill this need in the art, the inventors herein disclose a website that is configured with a travel agent path for access by travel agents to book rental vehicle reservations on behalf of their clients. Examples of features for this travel agent path include but are not limited to the maintenance of a client list for access by travel agents to quickly load client information onto website pages when booking rental vehicle reservations, the ability of travel agents to specify the commission percentages payable to them for the rental vehicle reservations they book, and the ability to associate multiple commission tracking identifiers with a single rental vehicle reservation such that commissions can be allocated to different parties who are associated with the commission tracking identifiers.

Also disclosed herein is a feature of the website where the confirmation page that is displayed on user computers includes a user-configurable display feature (e.g., a user-specified weather report and/or user-specified driving directions). Typical confirmation pages known to the inventors herein are read-only with respect to the information displayed therein. The confirmation page having the user-configurable display feature can be a printer-friendly confirmation page. Given that confirmation pages are often printed out by users prior to the start date of the reservation, the inventors believe it is desirous to allow such users to include display information on the confirmation page that is suited to their needs (such as, as noted above, weather reports and/or driving directions). As used herein, the term “confirmation page” refers to a page of the website that is displayed after the user has booked a rental vehicle reservation and that includes a display of pertinent aspects of the rental vehicle reservation such as the reservation duration, the pick-up and drop-off locations, the rental vehicle type, and the renter's name. Typically confirmation pages will also include a confirmation number that can be used by the renter and the rental vehicle service provider to identify that particular reservation.

These and other features and advantages of the present invention will be apparent to those having ordinary skill in the art upon review of the teachings in the following description and drawings.

### BRIEF DESCRIPTION OF THE DRAWINGS

FIG. 1 illustrates an exemplary system architecture for a preferred embodiment of the present invention;

FIG. 2 illustrates a deep-linking concept that affects a user's path through a rental vehicle reservation-booking website;

FIG. 3 illustrates an exemplary home page for a preferred embodiment of the present invention;

FIG. 4 illustrates an exemplary page for accessing a travel agent path for a preferred embodiment of the present invention;

FIGS. 5(a)-(d) illustrate exemplary home pages of a travel agent path for a preferred embodiment of the present invention;

FIGS. 6(a) and (b) illustrate respectively exemplary destination and port menus that aid in the location selection process;

FIG. 7 illustrates an exemplary choose vehicle page for a travel agent path in a preferred embodiment of the present invention;

FIG. 8 illustrates an exemplary choose location page for a travel agent path in a preferred embodiment of the present invention;

FIGS. 9(a) and (b) illustrate exemplary renter information pages for a travel agent path in a preferred embodiment of the present invention;

FIG. 10 illustrates an exemplary “my contacts” page for a travel agent path in a preferred embodiment of the present invention;

FIG. 11 illustrates an exemplary verify page for a travel agent path in a preferred embodiment of the present invention;

FIG. 12 illustrates an exemplary confirmation page for a travel agent path in a preferred embodiment of the present invention;

FIG. 13 illustrates an exemplary printer-friendly confirmation page for a travel agent path in a preferred embodiment of the present invention;

FIGS. 14(a)-(c) illustrate an exemplary “my account” page for a travel agent path in a preferred embodiment of the present invention;

FIG. 15 illustrates another exemplary “my contacts”/“my clients” page for a travel agent path in a preferred embodiment of the present invention;

FIG. 16 illustrates an exemplary add/edit contact/client page for a travel agent path in a preferred embodiment of the present invention;

FIG. 17 illustrates an exemplary past bookings page for a travel agent path in a preferred embodiment of the present invention;

FIG. 18 illustrates a processing flow for associating multiple commission tracking identifiers with a common rental vehicle reservation transaction;

FIG. 19 illustrates an exemplary “change travel agent identifier” page for a travel agent path in a preferred embodiment of the present invention;

FIGS. 20, 21(a), 21(b), 22(a), and 22(b) illustrate exemplary pages for a user-interactive confirmation page for a travel agent path in a preferred embodiment of the present invention; and

FIG. 23 illustrates an exemplary sign-up page for a travel agent user to create a user profile with the website.

### DETAILED DESCRIPTION OF THE PREFERRED EMBODIMENTS

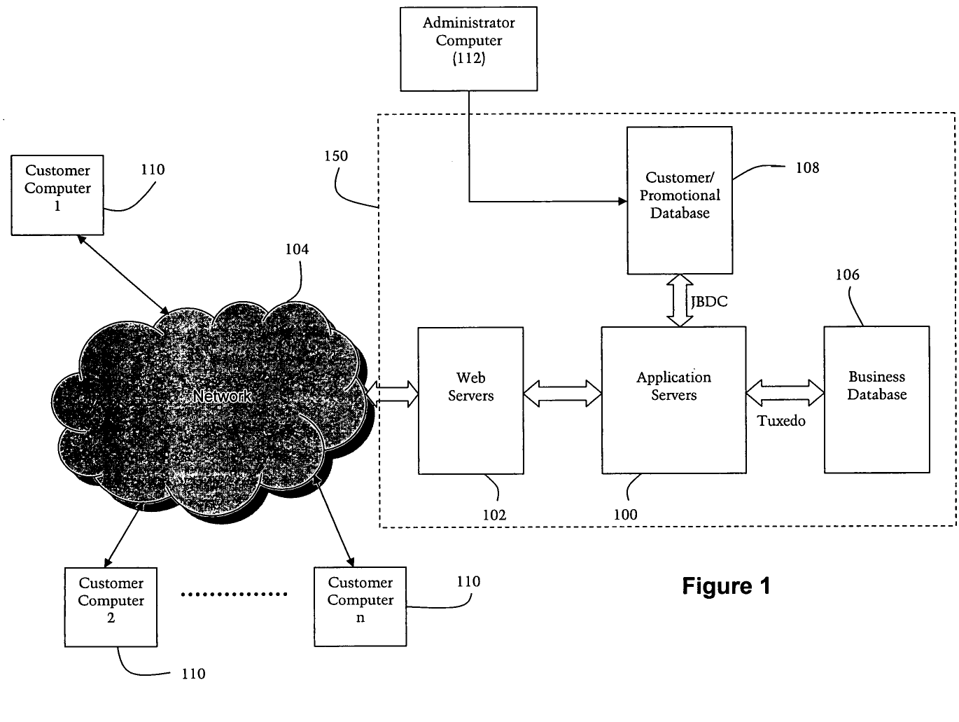

FIG. 1 illustrates a preferred system architecture for the present invention. A plurality of user computers 110 connected to a network 104 (such as the Internet) and using web browsing software can access a rental vehicle reservation booking website hosted by automated reservation transaction processing system 150. System 150 can be any computer that is network connectable. Preferably, the system 150 comprises an application server 100 (or application servers for redundancy purposes) a web server (or servers) 102, and memory units such as a customer/promotional database 108 and a business database 106. The application server 100 (1) interacts with the user computers via web server(s) 102 to obtain reservation data therefrom, (2) interacts with business database 106 via a connector interface such as Tuxedo, and (3) interacts with a customer/promotional database 108 via a connector interface such as JBDC. Business database 106 preferably stores all of the data pertaining to the rental vehicle service provider's branch locations, vehicle inventories, pricing, etc. Customer/promotional database 108 preferably stores the profiles of any registered customers (including the profiles of any customer entities such as travel agents, etc.), and data relating to any rental promotions being offered by the vehicle service provider. However, it should be noted that the data stored in database 106 and 108 can be consolidated into a single database, or further segmented into multiple other databases.

Optionally, an administrator computer 112 can be in communication with the customer/promotional database 108 to provide an authorized administrator with control over the content of database 108, thereby providing the administrator with control over the promotional offers available through the reservation booking website and control over how users associated with a customer account experience the reservation booking website, as described in the referenced Ser. No. 11/377,811 patent application.

The reservation booking website hosted by system 150 preferably provides a plurality of user-interactive pages for display on the user computers. These pages preferably interact with users of the user computers to obtain user input regarding a plurality of rental vehicle reservation characteristics (e.g., the location where the rental vehicle corresponding to the rental vehicle reservation is to be picked up, temporal information (e.g., starting/ending dates) for the reservation, the vehicle type (e.g., compact car, full-size car, etc.) for the reservation, renter information (e.g., name, address, etc.), etc.). As noted above, examples of pages for the rental vehicle reservation-booking website include a Home (H) page, a Choose Vehicle Type (CV) page, a Choose Location (CL) page, a Renter Information (RI) page, a Verify (V) page, a Confirmation (C) page and others, as described in the above-referenced related patent applications.

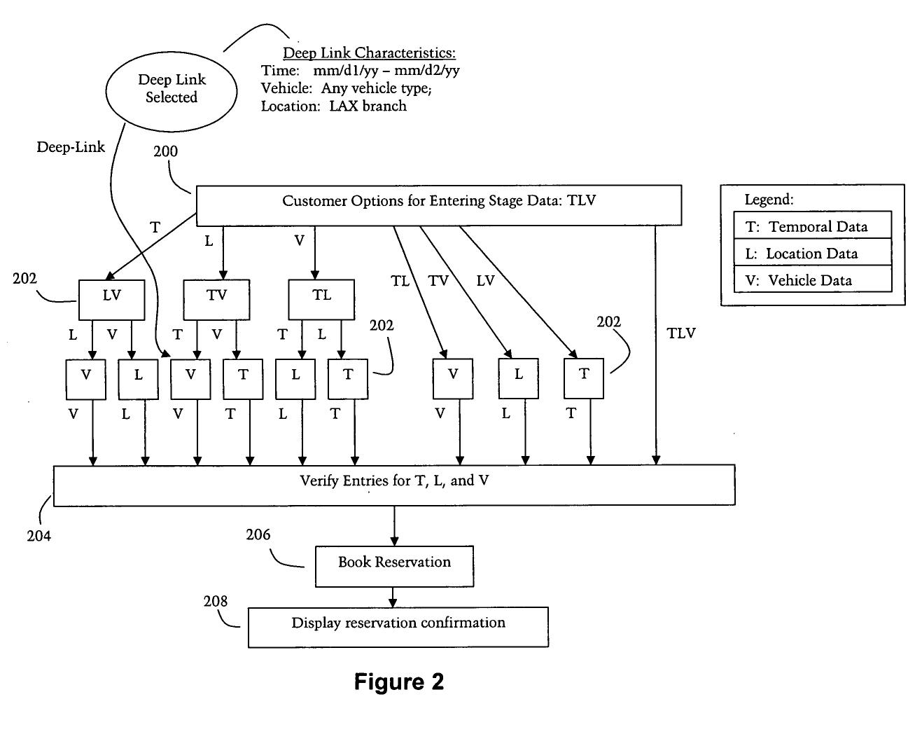

FIG. 2 also illustrates an exemplary navigational structure for a reservation booking website. In the example of FIG. 2, the different types of data needed from the user to successfully book a rental vehicle reservation are: (1) temporal data (T)—such as the starting and ending dates for the reservation, (2) location data (L)—such as an identification of the particular branch of the rental car company from which the user seeks a rental vehicle, and (3) vehicle data (V)—such as the type of vehicle the user wants to rent (economy, midsize, luxury, etc.). The user can submit values for these data types to the website via various paths. Boxes 200, 202, 204, and 208 in FIG. 2 each represent pages of the website, and the text within each box represents the data types for which the page requests data values from the user. Each arrow indicates a submission of data by the user, and the text adjacent each arrow represents the type(s) of data being submitted. It should be noted that the variety of paths shown in FIG. 2 is exemplary only—a practitioner of the present invention can choose to implement more or fewer paths in a website based on the practitioner's desires. For example, a practitioner of the present invention may wish to add renter information to the types of necessary data to complete a rental vehicle reservation.

When entering the website in a conventional fashion through the website's home page (H) 200, the user, depending on his/her desires, can either submit all data values for all necessary data types to the website via a single data exchange (see the path with the arrow labeled TLV), two data exchanges (see the paths labeled with the TL/TV/LV arrows), or in single-step fashion via three data exchanges. In instances where the user does not submit all necessary data types from the home page, one or more intermediate pages 202 are displayed for the user to submit remaining reservation data. Once the website has received all necessary data from the user, a verify page (V) 204 is presented from which the user can review his/her data entries and thereafter book the reservation if all is accurate (step 206). Upon booking the reservation, a confirmation page 208 is then displayed that summarizes pertinent details of the reservation.

FIG. 2 illustrates the “deep-linking” concept described in the above-referenced related patent applications by showing how a user can jump to an intermediate page 202 (or even a verify page 204) through selection of a deep-link. Upon selection of a deep-link, the user is dropped into the website at a stage of the reservation booking process commensurate with the conditions of that deep-link. Each deep-link is associated with at least one pre-selected reservation characteristic such that the user's reservation will be automatically loaded with that at least one characteristic upon selection of the deep-link. Because of this automatic loading of the pre-selected reservation characteristic, the user can bypass at least one data entry task of the website. FIG. 2 provides an example of deep-links, wherein the deep link exhibits the following pre-selected characteristics: the location is the LAX branch of the rental vehicle service provider and the time period is a date range (such as a specified weekend). This deep link is not restricted by vehicle type. Thus, upon user selection of this deep-link (e.g., by the user typing the deep link's Uniform Resource Locator (URL) into a browser or by selecting a link embedded into a page such as a page on which the deep-link was placed as an advertisement), the user is dropped into the website at a Choose Vehicle page, as shown in FIG. 2.

It is advantageous to tailor a user's path through the website based on the user's needs, particularly when that user is a repeat user such as a travel agent. To enhance a travel agent's experience with a rental vehicle reservation-booking website, the inventors herein disclose an improvement to such a website wherein a specialized travel agent path within the website is provided. The navigational route of the travel agent path preferably corresponds the route described in the above-referenced related patent applications with respect to the primary H, CL, CV, RI, V, and C pages, but is also preferably further enhanced such that the pages of the travel agent path are specially configured for travel agent users as well as the inclusion of some additional pages that are designed to accommodate a user profile maintained by the website for a travel agent user, as will be described hereinafter with respect to a variety of preferred pages of the travel agent path. However, it should be noted that other travel agent paths could be used in the practice of the invention. As used in the context of the travel agent path, a user or travel agent user refers to the travel agent himself/herself or a person empowered by the travel agent to actually access the website to book rental vehicle reservations on behalf of a client. As such, the travel agent users of the travel agent path may also include for example an assistant or a secretary to a travel agent.

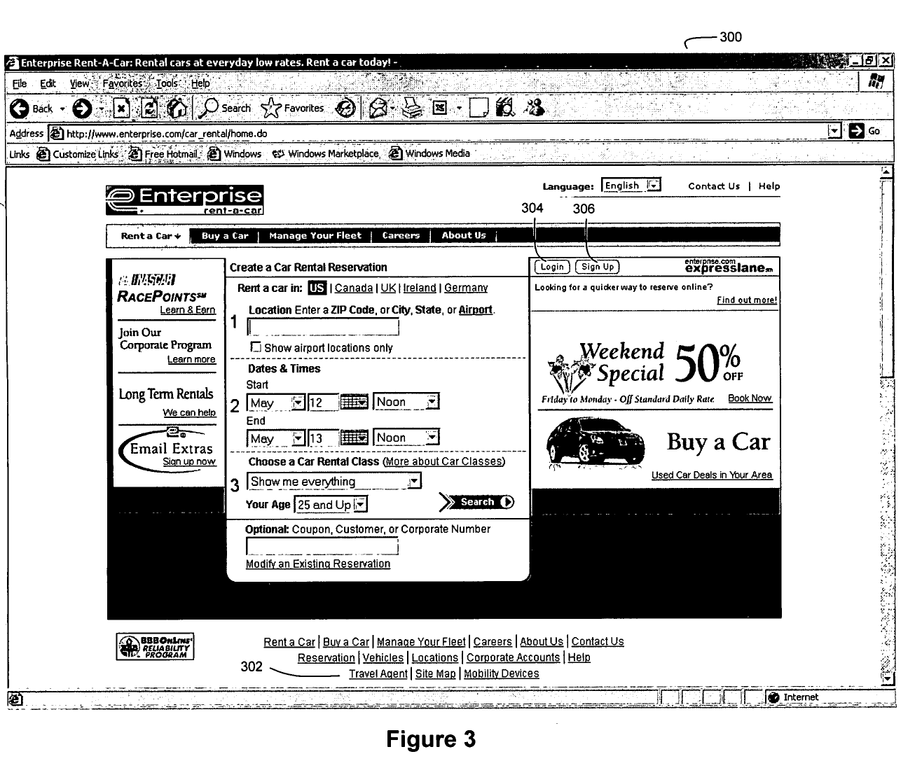

FIG. 3 illustrates an exemplary home page 300 of the website. The home page 300 preferably includes a link 302 that, upon user selection, will route the user to the start of the preferred travel agent path. It should be noted that the website can also be configured to allow the travel agent to access the travel agent path through button 304, which allows the user to sign in using a user identifier and password. If the travel agent has an associated user ID and password, he/she can also access his/her user profile stored in database 108. This profile will preferably identify the user as a travel agent and drop the user into the website's travel agent path. If the user has not yet created a user profile in database 108, he/she can do so by selecting button 306.

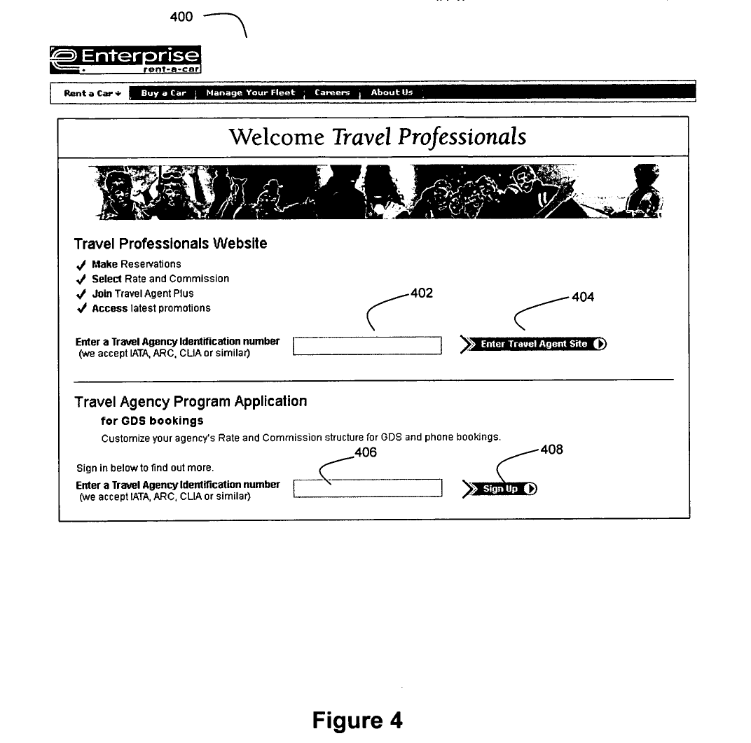

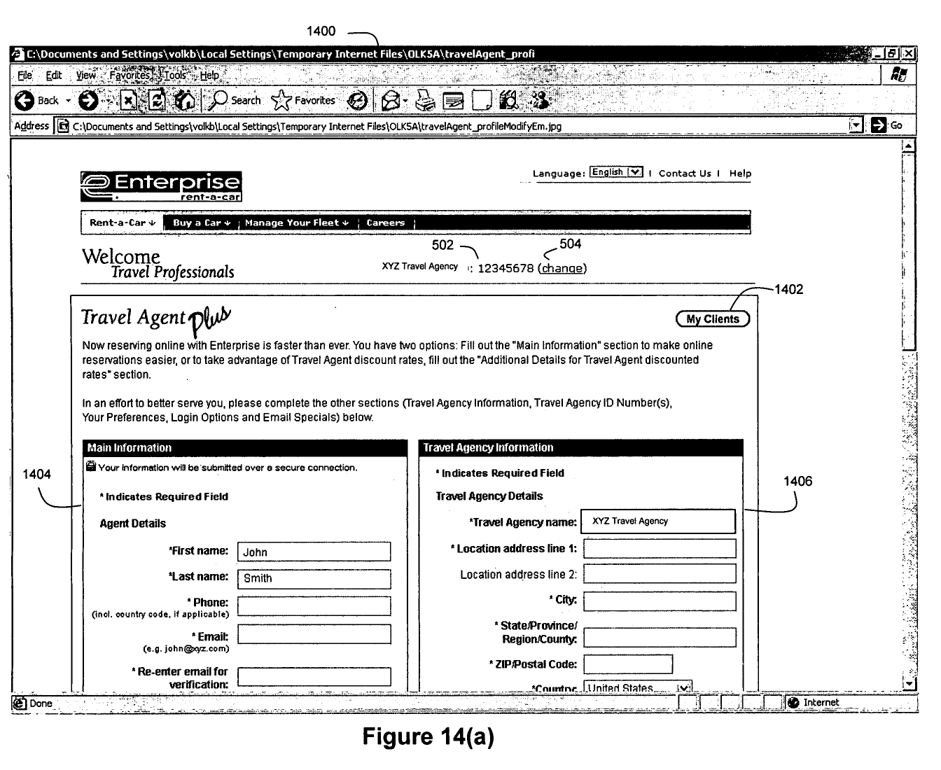

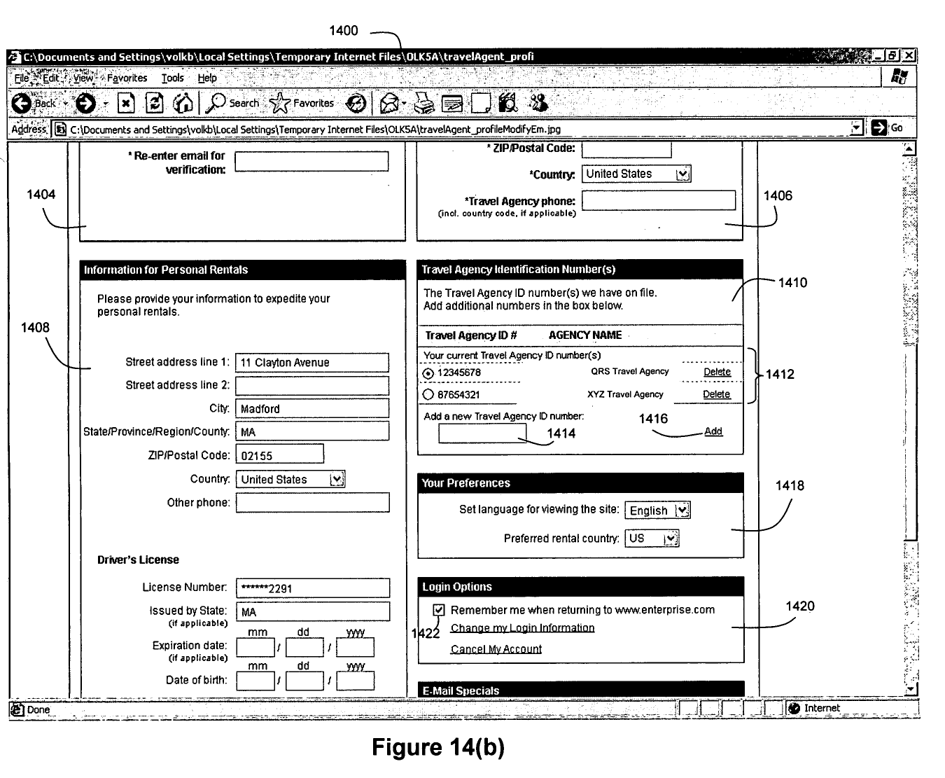

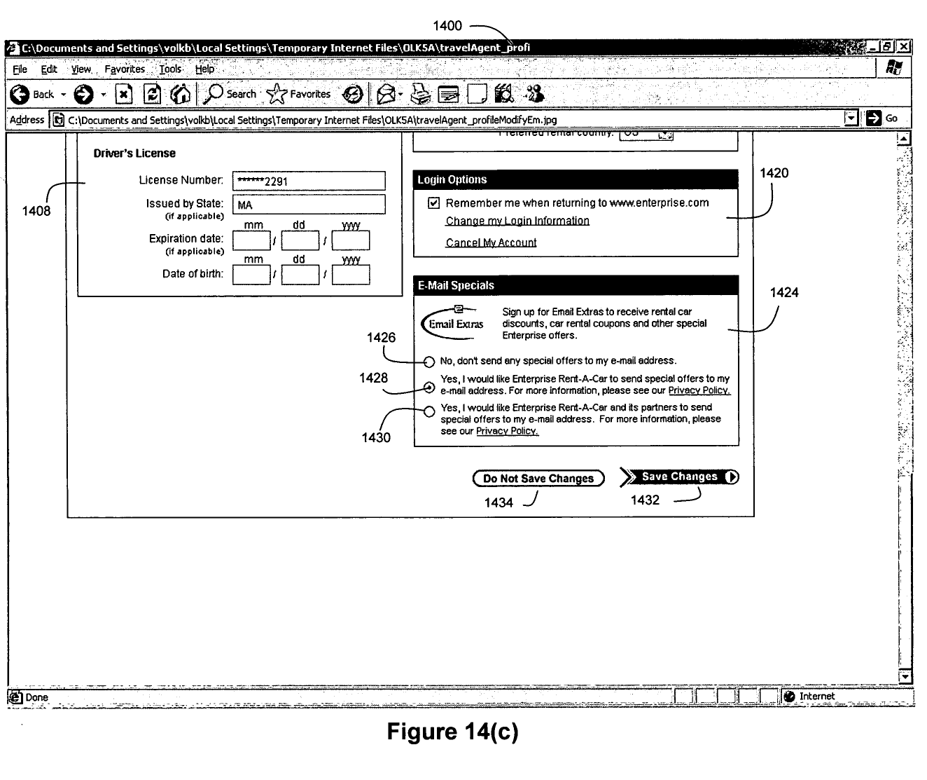

FIG. 4 illustrates an exemplary page 400 that would be reached upon user selection of link 302 from home page 300 of FIG. 3. Through field 400, the user can provide his/her travel agent identifier to access the website's travel agent path. The travel agent identifier is preferably a unique identifier for the travel agent and is stored in database 108. Upon user selection of button 404, the website preferably accesses database 108 to verify the user-entered travel agent identifier. If the user provides a travel agent identifier that matches one stored in the database 108, then the website preferably retrieves the travel agent's profile from the database for use during the travel agent's session with the website. If the user has not previously registered with the website as a travel agent, he/she may do so by entering the applicable travel agent identifier in field 406 followed by selection of button 408. This action will preferably route the user to page 1400 of FIGS. 14(a)-(c) as described hereinafter.

Any reservations booked by the travel agent will be associated with the travel agent's identifier so that commissions can be paid to the travel agent when the travel agent's client rents a vehicle in accordance with the rental vehicle reservation. Typically, commissions become payable to the travel agent upon closing of the rental contract corresponding to the subject reservation, wherein the commission is based on the actual rental contract opened and closed by the renter. However, it should be noted other commission procedures could be adopted by a rental vehicle service provider. Preferably the travel agent identifier is one of the standard travel agent identifiers that are already used in the industry, such as Airlines Reporting Corporation (ARC) numbers, International Airport Transport Association (IATA) numbers, Cruise Line International Association (CLIA) numbers or the like. However, it should be noted that any identifier could be used, including an identifier issued through the website.

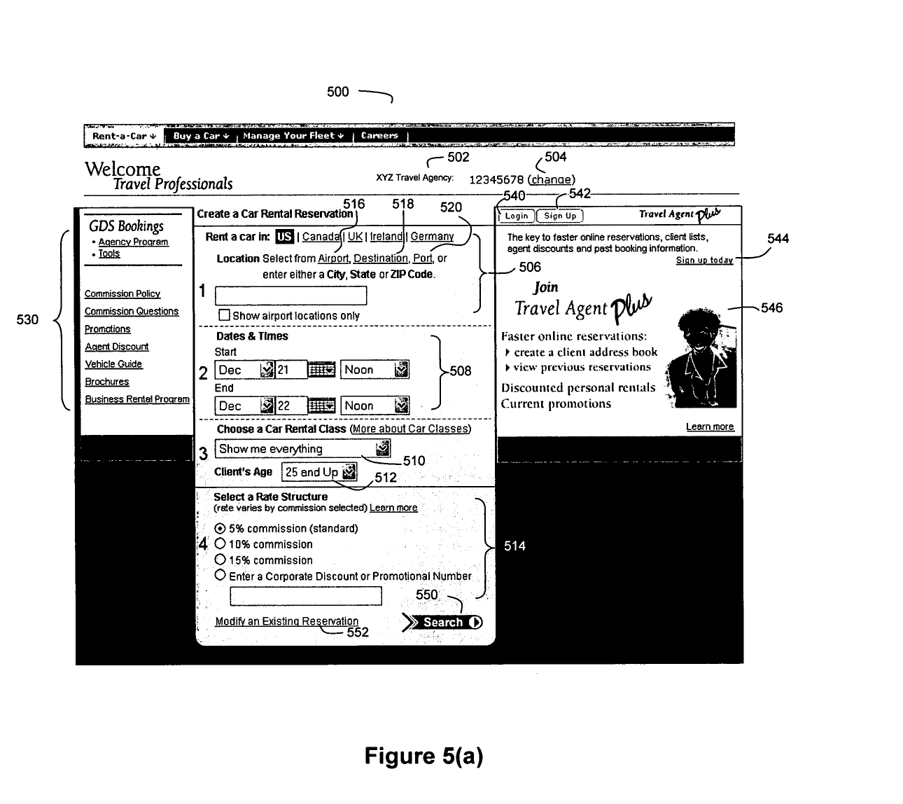

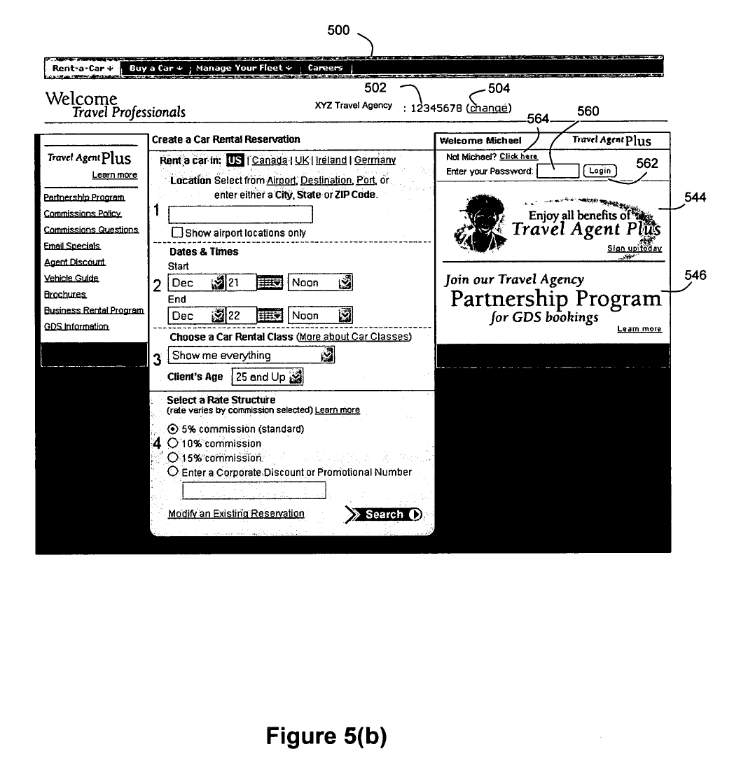

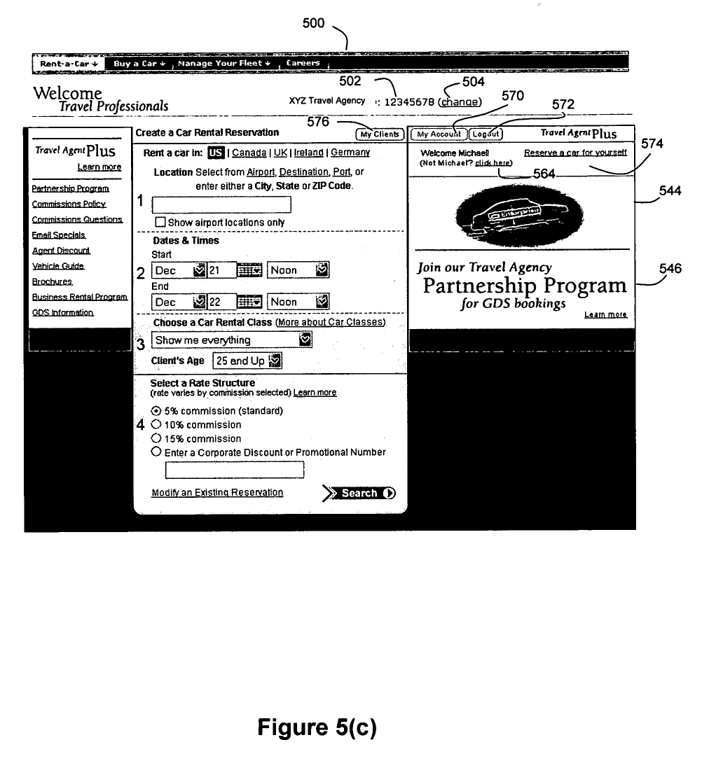

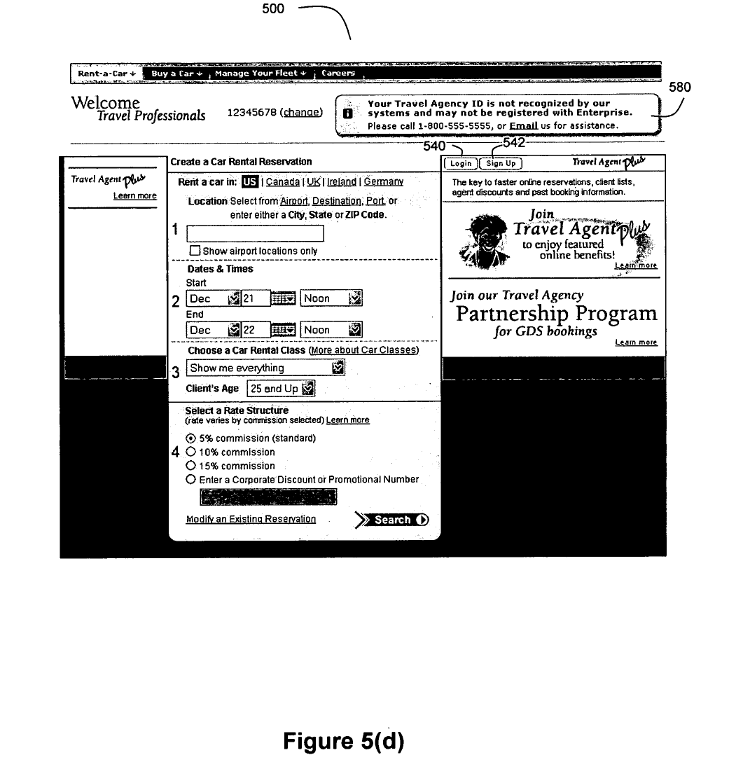

If the travel agent identifier does not match a travel agent identifier that has previously been registered with the website, then the page 500 of FIG. 5(d) is preferably displayed on the user computer. Page 500 of FIG. 5(d) is a home page within the travel agent path that notifies the user via section 580 that his/her travel agent identifier was not recognized by the website and asks the user to contact a customer service representative for the website via telephone or email to rectify the situation, for example by registering the travel agent identifier with the website. It should be noted that this process could also be automated via a page that is reached from a link in section 580, wherein that page is configured to provide a travel agent identifier to requesting parties. Preferably, home page 500 of FIG. 5(d) is a stripped down version of the travel agent path home pages depicted in FIGS. 5(a)-(c). For example, preferably the travel agent-related links on the left side of page 500 shown in FIG. 5(a)-(c) are not included in page 500 of FIG. 5(d).

Also, it should be noted that the identifier entered in field 402 can be specific to an individual travel agent person or to a travel agent entity that comprises a collection of individual travel agent persons, dependent upon the particular business situations of the different travel agent users of the website. Preferably, the travel agent identifier is applicable to a travel agent entity, and then each individual travel agent who works for the travel agent entity, will then maintain a user profile with the website. However, other options can be practiced. For example, the travel agent entity may also maintain a single user profile to which all of its travel agent individual employees have access.

FIG. 5(a) illustrates home page 500 that is reached by the user after the user has entered the travel agent path. The name of the travel agent stored in database 108 corresponding to the user-entered identifier in field 402 is displayed in section 502. Furthermore, through buttons 540 and 542, the user can sign into (or create) a user profile that may be stored for the user in database 108, much like the buttons 304 and 306 shown in FIG. 3. It should be noted that in some circumstances, a practitioner of the present invention may not want to include both a travel agent sign-in through page 400 and a profile sign-in through button 540. For example, in some instances a practitioner of the present invention may desire that the website automatically log the user into his profile upon user entry of an appropriate travel agent identifier in field 402. In such instances, the user of buttons 540 and 542 may be redundant. However, in other instances such bifurcated access may be desirable. For example, as noted above, in instances where a travel agent entity is comprised of a collection of individual travel agents, each individual travel agent may wish to maintain his/her own profile while still using the travel agent entity's identifier.

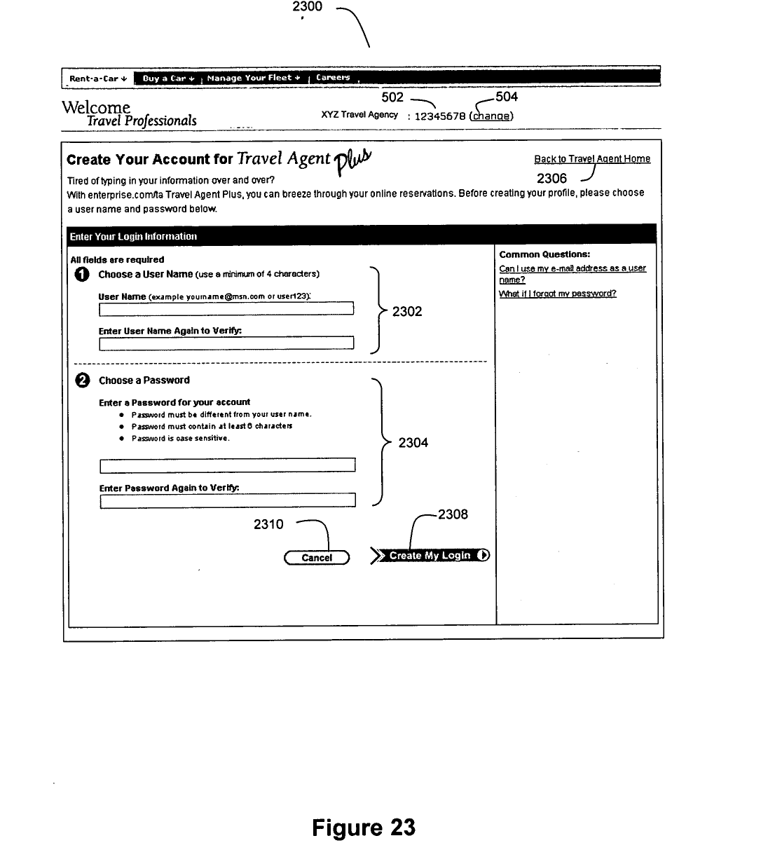

If the travel agent user wants to sign up for a travel agent user profile, he/she can do so by selecting link 542. Upon selection of link 542, page 2300 of FIG. 23 is preferably displayed. Within section 2302, the travel agent user preferably is instructed to enter (twice to minimize errors arising from mistyping) a user name for the travel agent user profile. Within section 2304, the travel agent user is preferably instructed to enter (twice once again) a password for the travel agent user profile. Upon doing so, the user can create a profile accessible by the user name and password entered in sections 2302 and 2304 via selection of button 2308. Upon selection of button 2308, the user name is preferably checked against already existing user names to confirm its uniqueness. If the user name is confirmed as unique, then page 1400 of FIGS. 14(a)-(c) is preferably displayed, the functionality of which is described hereinafter. If not unique, the user can be re-prompted to enter a different user name password in sections 2302 and 2304. Button 2310 can be selected to cancel the profile creation and return the user to page 500 of FIG. 5(a). Similarly, link 2306 can be selected to return the user to the home page 500 of FIG. 5(a).

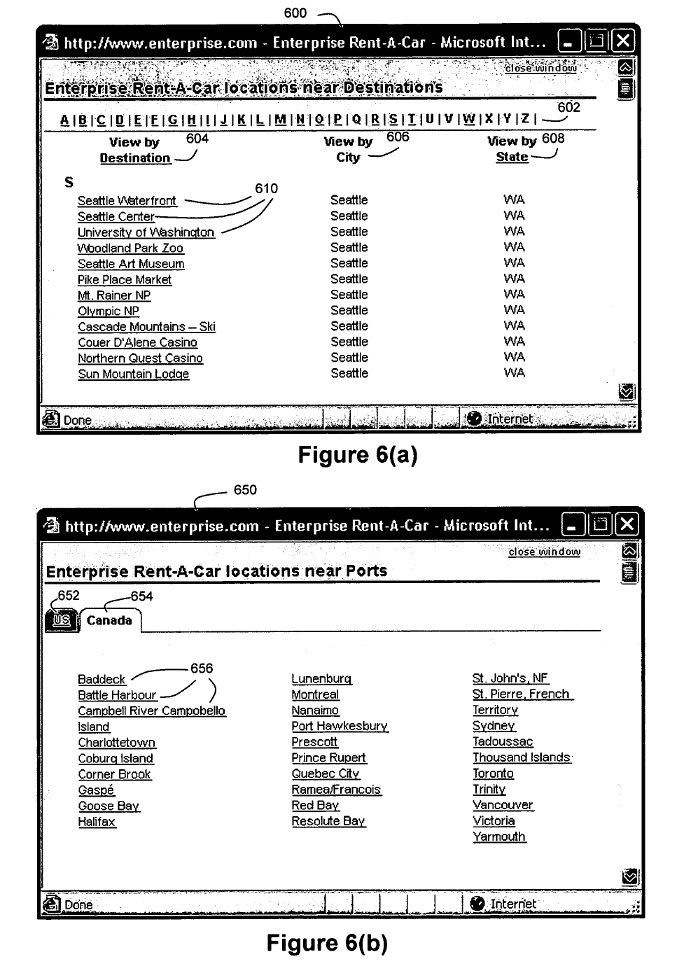

Sections 506, 508, 510, and 512 operate largely as described in connection with the above-referenced related patent applications, namely as a means for obtaining location, temporal, renter age, and vehicle type information for the reservation from the user. However, it should be noted that section 506 includes two links 518 and 520 (in addition to link 518 that is user-selectable to display a list of available airport branch locations for the rental vehicle service provider) that are user-selectable to display the menus of FIGS. 6(a) and (b) respectively.

Through link 518, the travel agent user can access a menu 600 of popular travel destinations, as shown in FIG. 6(a). Preferably the travel destinations are organized in some convenient fashion, such as alphabetically by the destination's name (see column 604), the city in which the destination is located (see column 606), or the state in which the destination is located (see column 608). The travel agent user can preferably sort the destinations by any one of those three categories by selecting the applicable column links. Further still an alphabet bar 602 is provided which further allows the travel agent user with the ability to narrow the list of potential destinations. For example, menu 600 of FIG. 6(a) has been sorted by city name and further narrowed to show destinations in cities beginning with the letter “S”. Each listed destination 610 is preferably user-selectable.

Through link 520, the travel agent user can access a menu 650 of popular travel ports of call, as shown in FIG. 6(b). Preferably the travel ports of call are organized in some convenient fashion, such as alphabetically by the country (see folder tabs 652 and 654). Each listed port 656 is preferably user-selectable.

As used herein in connection with menus 600 and 650, “destination” refers to a location that is generally considered a traveler attraction and/or a place where travelers can be expected to visit when traveling (e.g., a theme park, a particular hotel, the downtown area of a city, a cruise port (thus, the ports of call in menu 650 can be considered a subset of the class “destinations”), a popular travel region such as Napa wine country in California, and the like). These destinations are labeled with names reflective of the destination rather than a technical label that a user such as a travel agent may not readily associate with the destination (for example, a listing that is exclusively by address and zip code). In doing so, menus 600 and 650 can aid the travel agent user in quickly identifying the branch location of the rental vehicle service provider at which the reservation should be booked, as explained below, without the need for the travel agent to be familiar with specific street names and/or addresses in the area of interest.

Upon user-selection of a destination 610 or port 656 from the menu 600 or 650, that destination/port is preferably loaded into the location field of section 506. Thereafter, upon user selection of the search button 550, the website will access database 106 to determine which branch (or branches) is (or are) closest to the selected destination/port. This determination can be made through a variety of techniques, including but not limited to indexing tables that associate branch locations with destinations/ports, or on the fly locator technologies that will compute which branch locations are closest to the destinations/ports based on geographic coordinates therefor. Thereafter, in instances where the selected destination/port is associated with a plurality of branch locations, when the travel agent user reaches a choose location page, he/she will be presented with a list of branch locations near the selected destination/port (preferably with either or both of the branch location nearest the destination/port and the airport branch location nearest the destination/port being highlighted in some manner). Alternatively, in instances where the selected destination/port is associated only with a single branch location, the travel agent user's path through the website can bypass the “choose location” page altogether.

Section 514 of page 500 provides the travel agent user with the ability to define the commission structure for the reservation being booked. Preferably the travel agent user is provided with a number of optional commission percentages (e.g., 5%, 10%, or 15% as shown) that travel agent user can define for the rental vehicle reservations that they book on a per rental vehicle reservation basis. The user's commission percentage selection will define the commission that is paid to the travel agent when the travel agent's client fulfills the rental vehicle reservation. Preferably, the website will adjust the rate charged to the travel agent client to reflect the commission percentage chosen by the travel agent user. For example, if the travel agent user selects a 10% commission, the rental vehicle service provider may want to upwardly adjust the price for the rental transaction defined by the rental vehicle reservation to reflect the increased commission (for example by passing the entire increase in commission amount onto the renter's price or by passing a portion of the increase in the commission amount on to the renter's price). Further, if the travel agent user wants to apply a corporate discount rate or a promotional offer rate to the reservation, he/she can enter the appropriate identifier for the corporate discount or promotional offer through the corresponding field shown in section 514. Preferably, each corporate discount identifier and/or promotional offer identifier will have a commission identifier associated therewith that defines the commission to which the travel agent is entitled when that corporate discount or promotional offer is used to book a reservation. It should also be noted that section 514 can also include a field for user entry of a commission percentage to be applied to the reservation. Such a user entry field can be used instead of or in addition to the plurality of user-selectable commission percentage options that are shown in section 514 of FIGS. 5(a)-(d).

Link 552 can be selected by the travel agent user if he/she wishes to modify a previously-created reservation. Also, section 530 of page 500 includes a variety of links to information materials that may be of interest to travel agent users. Sections 544 and 546 can be populated with images and deep-links of the travel agent's choosing via the technology disclosed in the above-referenced Ser. No. 11/377,811 patent application.

As explained in greater detail below, link 504 can be selected by the travel agent user if the travel agent user wishes to change the applicable travel agent identifier for the reservation or add an additional travel agent identifier for the reservation.

FIG. 5(b) depicts the home page 500 that would be displayed on the travel agent user's computer when that particular user computer has been recognized as belonging to the travel agent user (such as through the placement of a cookie on the user computer by the website). To log into the travel agent user's stored profile, the travel agent user preferably must provide the profile's password in field 560, followed by the selection of button 562. If the travel agent user is not the same person as the one recognized by the website, then the travel agent user can select link 564 to access a different page such as the home page 500 of FIG. 5(a).

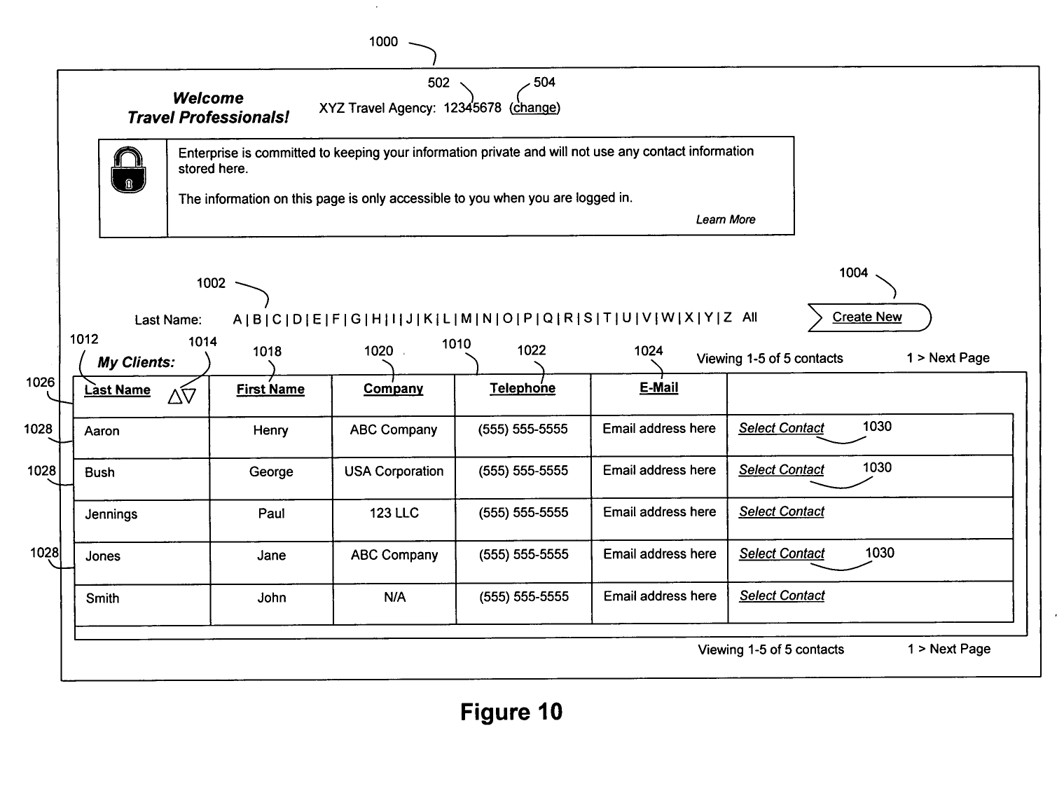

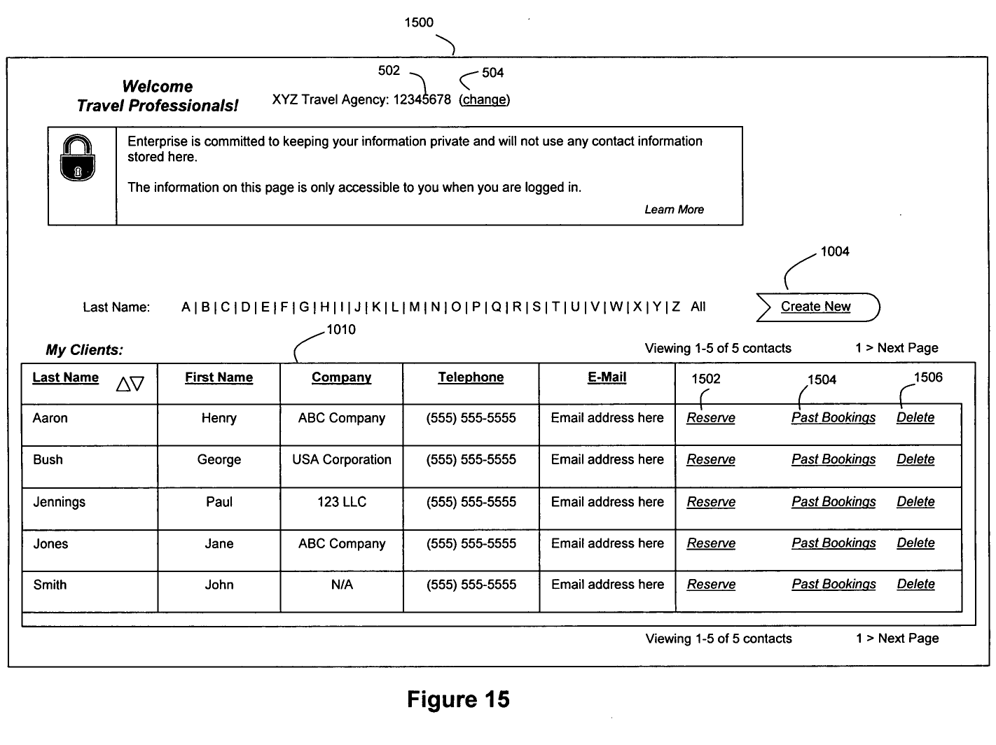

FIG. 5(c) depicts the home page 500 that would be displayed on the travel agent user's computer after the travel agent user has logged into his/her profile. Link 572 is then selectable to log the user out of the profile. If the travel agent user wants to access the details of his/her stored profile, user selection of link 570 will operate to display page 1400 of FIG. 14(b) whose functionality will be described hereinafter. Also, sometimes a travel agent may want to book a rental vehicle reservation for himself/herself rather than on behalf of a client. If a travel agent wishes to do so, he/she can select link 574. Upon selection of link 574, the travel agent user is preferably dropped into a personalized path of the website based on the user profile for the travel agent user stored in database 108, as described in the above-referenced related patent applications. Also, link 576 (for “my clients” or “my contacts”) is preferably selectable by the travel agent user to access a page that lists the travel agent user's clients who are stored in his/her user profile, as explained in greater detail below in connection with FIGS. 10 and 15.

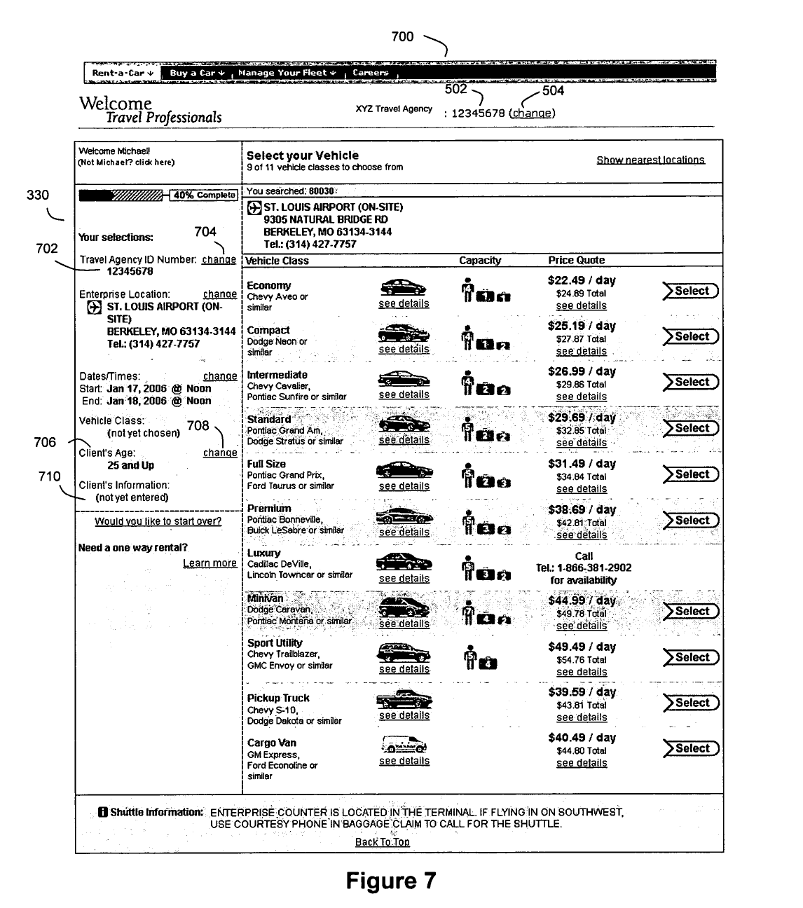

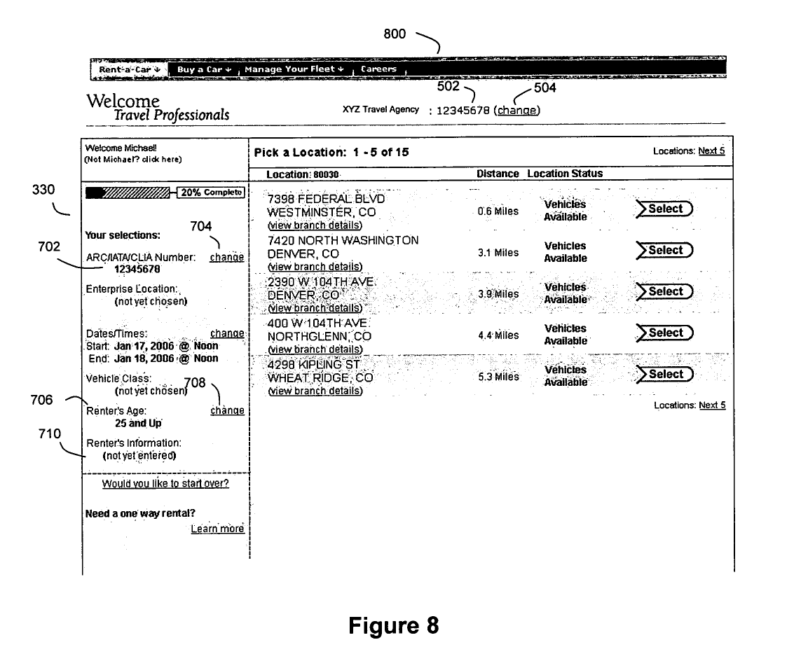

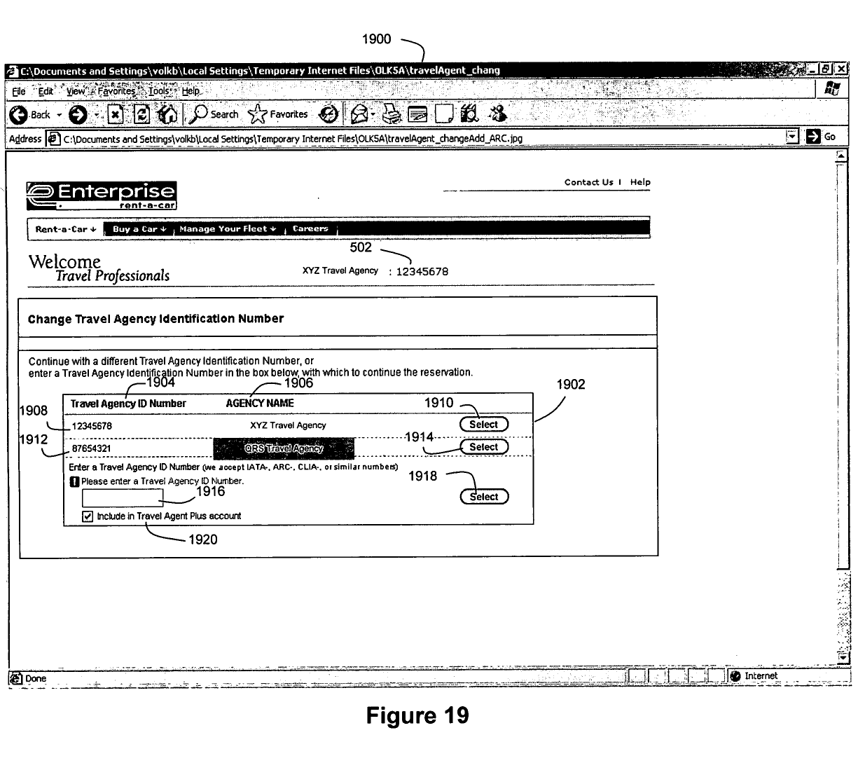

Depending upon the user input in sections 506, 508, 510, and/or 512 of the home page, the travel agent user will be routed to an appropriate later page in the travel agent path of the website, as described in the above-referenced related patent applications. However, the various pages of the website that are within the travel agent path are preferably provided with additional functionality that is specific to the travel agent's business needs. For example, FIG. 7 depicts an exemplary “choose vehicle” page 700 that displays one or more vehicle types that are available for selection by the travel agent user as part of the client's rental vehicle reservation. Summary section 330 of page 700 preferably operates as described in the above-referenced related patent applications, but also further includes some entries that are travel agent specific. Section 702 of summary section 330 preferably identifies the travel agent who is booking the reservation (by name and/or travel agent identifier). An edit link 704 is preferably provided adjacent to this information in case the travel agent user wants to change this information. Upon selection of edit link 704, the travel agent user is preferably routed to page 1900 of FIG. 19 to thereby allow the travel agent user to modify the travel agent identifier corresponding to the reservation. Furthermore, summary sections 706 and 710 preferably identify the age and general information for the client on whose behalf the travel agent user is creating a rental vehicle reservation. Edit links (such as edit link 708 adjacent to the client age information 706 for editing the client's age) are included in summary section 330 to make any necessary modifications to previously-entered reservation information. FIG. 8 depicts an example of a “choose location” page 800 within the travel agent path, also with the modified summary section 330.

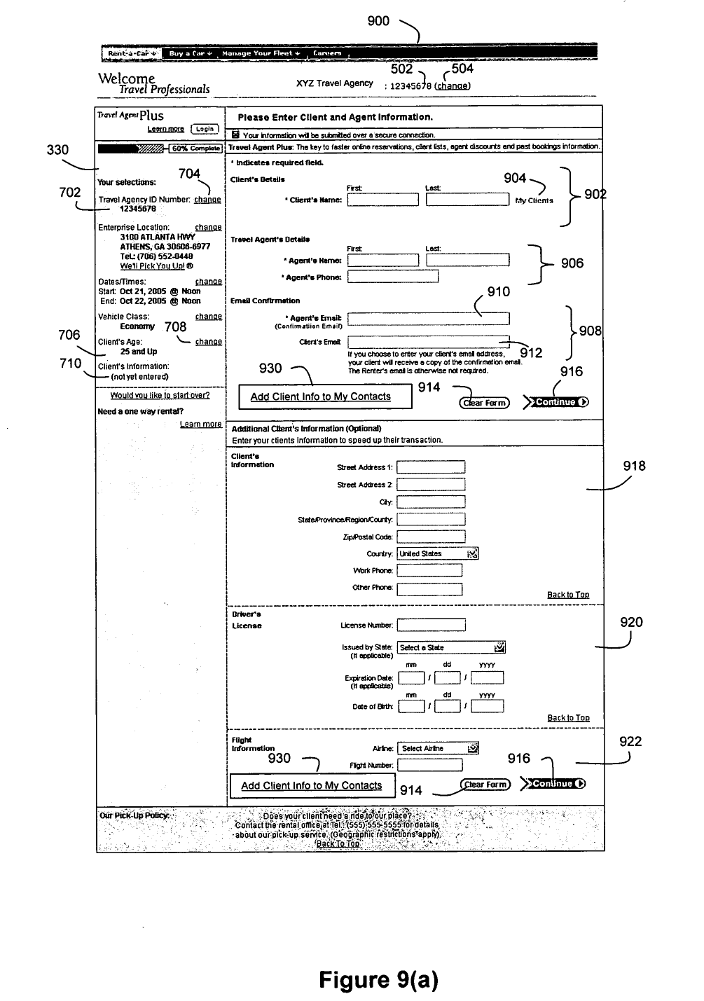

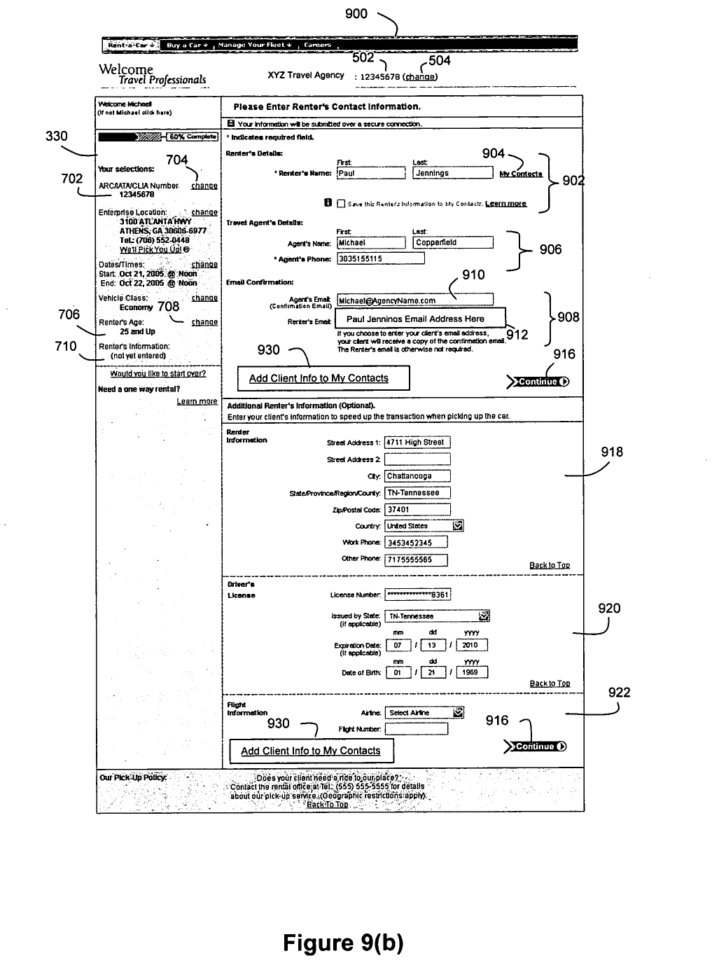

FIG. 9(a) depicts an exemplary renter information (RI) page 900 that is displayed within the travel agent path. Section 902 provides the travel agent user with data entry fields in which client renter information such as the client's first and last name can be entered.

Section 906 provides the travel agent user with data entry fields in which travel agent user information such as the travel agent's first and last name and telephone number can be entered. If the travel agent has logged into his/her stored profile, preferably this information can be automatically loaded into section 906 from the profile.

Section 908 provides the travel agent user with data entry fields in which he/she can enter the email addresses to which confirmations of the rental vehicle reservation will be sent (preferably a field 910 for the travel agent's email address and a field 912 for the client renter's email address). Once again, if the travel agent has logged into his/her stored profile, preferably the travel agent's email address can be automatically loaded into field 910 from the profile. Also, the website will preferably use the email addresses entered in section 908 to determine the email addresses to which a confirmation email will be sent upon booking of the rental vehicle reservation by the travel agent user. Thus, by entering an email address for his/her client in section 908, the travel agent user can control the website's delivery of a confirmation email to his/her clients.

Section 918 provides the travel agent user with data entry fields in which client renter information such as the client renter's address and telephone number(s) can be entered.

Section 920 provides the travel agent user with data entry fields in which client renter information such as the client renter's driver's license information can be entered.

Section 922 provides the travel agent user with data entry fields in which client renter information such as any flight information relevant to the client renter's rental vehicle reservation can be entered.

Button 916 is user-selectable to enter the information on page 900 into the reservation transaction. Button 914 is user-selectable to clear the fields of page 900 of any previously-entered information.

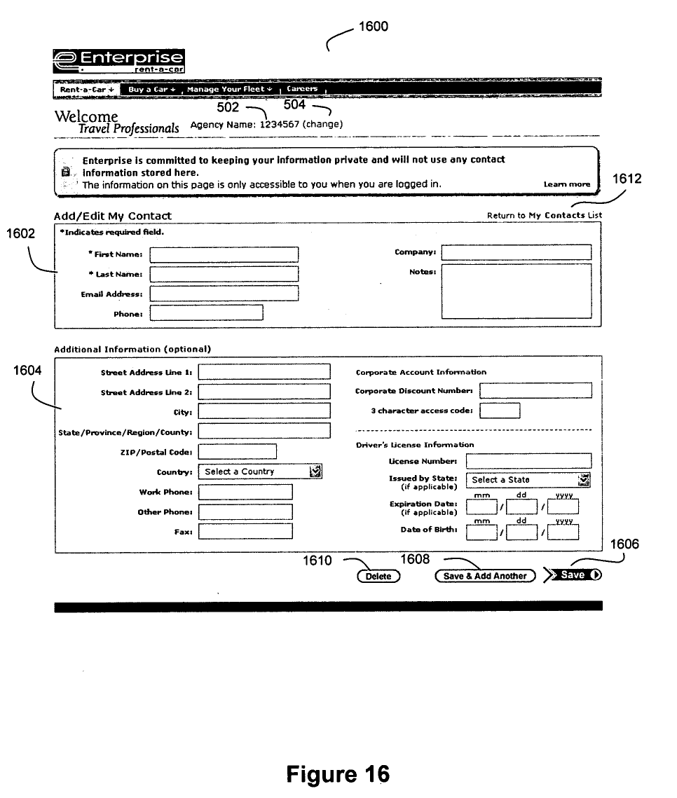

A convenient tool for enhancing the travel agent's ability to book rental vehicle reservations is the “my contacts” or “my clients” link 904. To save time and data entry effort for the travel agent user, database 108 preferably maintains a listing of the travel agent's clients. This client information can be stored in database 108 in any of a number of ways (see for example, the discussions below in connection with button 930 and FIG. 16). The website preferably provides travel agent users with the ability to quickly load client information from database 108 into the various fields of page 900. To do so, the travel agent user can select link 904.

Upon user selection of link 904, the page 1000 of FIG. 10 is displayed. Page 1000 lists in table 1010 all of the clients for the travel agent user that are stored in database 108. An alphabet bar 1002 is preferably user-interactive to facilitate the travel agent user's navigation of table 1010, particularly when the travel agent has a large client base.

Table 1010 preferably lists a plurality of clients 1028 with various aspects of the client information stored in database 108 being listed in the table's columns. Within column 1012, table 1010 lists each client's last name. Column 1012 is preferably sortable in both alphabetical and reverse alphabetical order via arrows 1014. Within column 1018, table 1010 lists each client's first name. Within column 1020, table 1010 lists the company associated with each client (if applicable). Within column 1022, table 1010 lists each client's telephone number. Within column 1024, table 1010 lists each client's email address. From the information in table 1010, the travel agent user should readily be able to identify the client on whose behalf he/she is booking a rental vehicle reservation. To select a client for the reservation, the travel agent user can select link 1030 adjacent to each client's information in table 1010. User selection of link 1030 is preferably effective to return the travel agent user to page 900, but with the selected client's information from database 108 automatically loaded into the client-specific fields of page 900. FIG. 9(b) depicts an example of page 900 after the travel agent user has selected “Paul Jennings” from table 1010.

If the travel agent user wishes to add a new client to his/her contact list, he/she can begin the process of adding a new client by selecting the “create new” button 1004. User selection of button 1004 is effective to display page 1600 of FIG. 16, whose functionality will be described below.

Also, it should be noted that for some travel agent entities, it may be desirable for the travel agent's client list to be accessible to multiple individual travel agents who are members of the travel agent entity. In such instances, database 108 preferably stores the client list such that the names on the list are applicable to all individual travel agents of the travel agent entity. In such circumstances, and using the example of FIG. 10, the contact list in table 1010 will be reflective of the client list of the XYZ Travel Agency, and not necessarily just the client list of the particular travel agent user on whose computer page 1010 is displayed.

Furthermore, database 108 is preferably capable of storing a variable amount of information for each client. For example, for some clients, the travel agent may only know of basic details such as name and telephone number while for other clients the travel agent may know more detailed information (e.g., also an email address, address, etc.), while for still other clients, the travel agent may know all pertinent information relative to the fields of page 900. Thus, upon user selection of link 1030, the website preferably automatically loads all available information for the selected client into the corresponding fields of page 900. If some fields are left blank in page 900, then the travel agent can fill those fields in manually if necessary.

Returning to FIGS. 9(a) and (b), it should be noted that the website can respond to user selection of the “continue” button 916 by automatically adding the client information entered on page 900 into the database 108 as a new client for the travel agent (if a client of that name was not already in the database 108 for that travel agent). If a client of that name is already stored in database 108 for that travel agent, the website can prompt the travel agent user whether the two clients of the same name are the same person. If the travel agent responds that the two are different persons, then that website can add a new entry to the travel agent's client list in database 108. If the travel agent responds that the two are the same person, the website can further prompt the travel agent user as to whether the client information entered on page 900 should replace any previously-stored information for that client (to the extent that there are differences between such information). If the travel agent responds to request an overwrite, the database 108 can be updated accordingly.

In addition or alternatively to this functionality, button 930 can also be provided on page 900. User selection of button 930 would operate to add the client information entered on page 900 to the travel agent's client list. Similar functionality to the paragraph described above can be implemented to account for instances where a client of the same name is already stored in table 1010 for that travel agent.

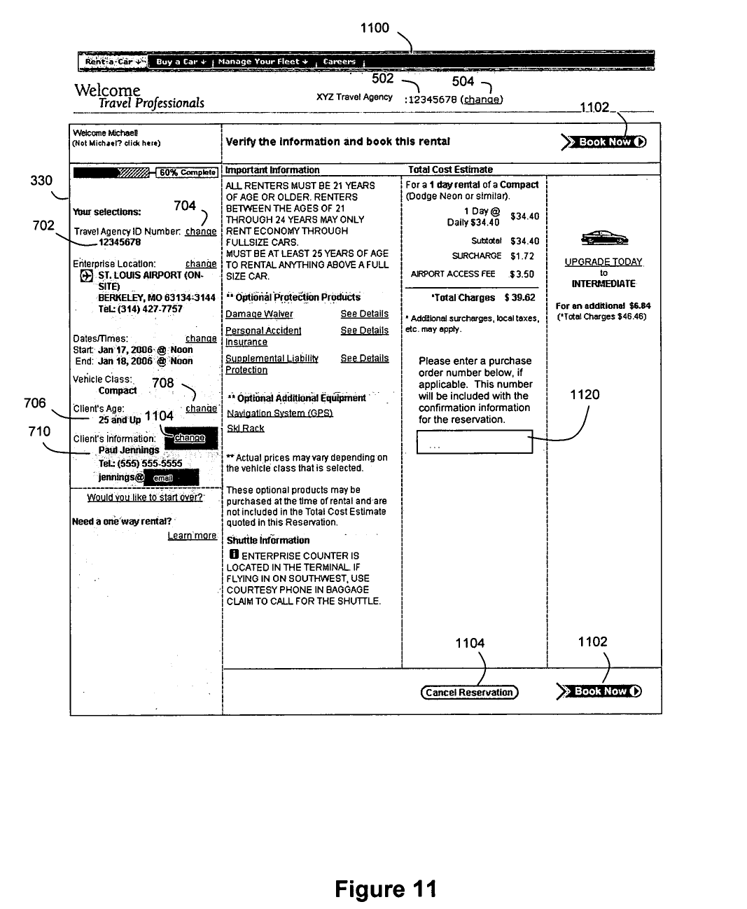

Once the travel agent user has supplied all necessary components of the reservation, then the verify page 1100 is preferably displayed on the travel agent user's computer. Summary section 330 preferably summarizes all of the previously-supplied information for the reservation. Now that the travel agent user has populated the reservation with the client information from page 900, information 710 in the summary section preferably has an adjacent edit link 1104 that is user-selectable to recall page 900 to thereby allow the travel agent user to modify the client information. The verify page also provides additional information about the reservation such as estimated cost, and the like, as shown in FIG. 11. User selection of the “book now” button is effective to book the reservation with the rental vehicle service provider and store the reservation in database 106 where it will await fulfillment by the client. Also, user selection of button 1102 is preferably effective to cause the website to email a copy of the confirmation page for the reservation (described below) to both the listed email address for the travel agent user and the listed email address for the client renter. User selection of button 1104 is effective to cancel the proposed reservation.

Optionally, page 1100 may include a field 1120 for the travel agent user to enter a purchase order number for the reservation. This purchase order number may be a number that the travel agent uses for his/her own record-keeping. Upon entry of a purchase order number in field 1120, this number can be stored by the website in association with the reservation, and in turn be included on the confirmation page or other billing information for the reservation. It should be noted that the purchase order number entry field 1120 can also be included on other pages of the travel agent path, for example on the home page or some other intervening page of the website encountered between the home page and the verify page. Similarly, summary section 330 can also include a section that lists the user-entered purchase order number for the reservation together with an adjacent edit link, the adjacent edit link being user-selectable to allow the user to change the applicable purchase order number for the reservation.

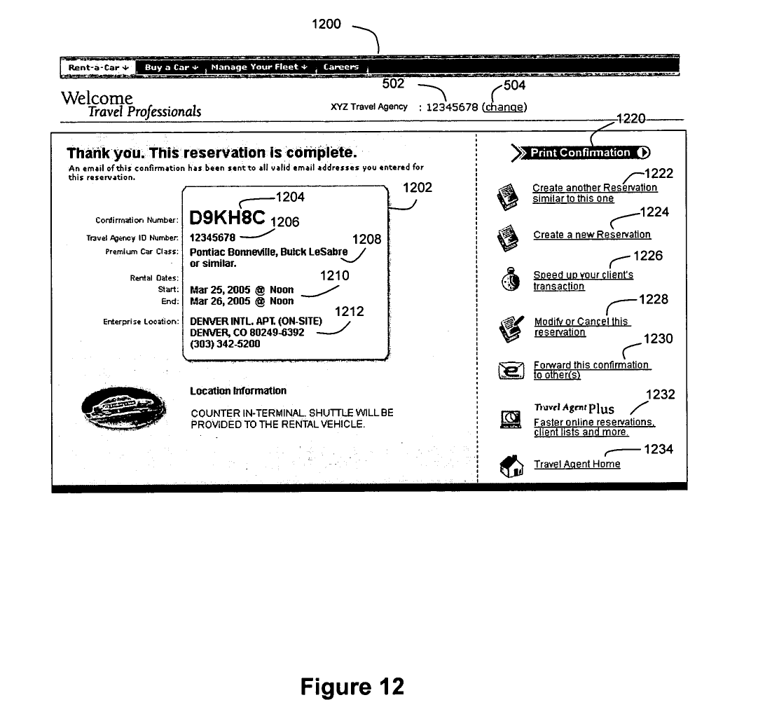

FIG. 12 depicts an exemplary confirmation page 1200 that is displayed upon user selection of button 1102. Section 1202 of the confirmation page preferably displays the pertinent details for the booked reservation including the confirmation number 1204, travel agent identifier 1206, the vehicle type 1208 for the reservation, the start/end dates/times 1210 for the reservation, and the branch location 1212 where the reservation is to be fulfilled.

To print the confirmation information, the user can select “print confirmation” button 1220. Furthermore, the confirmation page 1200 may also include a link 1222 that is effective upon user selection to begin a process of creating a new reservation with features similar to the booked reservation described on the confirmation page (for example, user selection of link 1222 can create a new reservation with the same components and return the user to the verify page from which the user can make appropriate changes via the edit links in summary section 330), a link 1224 that is user-selectable to create a new reservation (for example by returning to the home page 500 that corresponds with whether the travel agent user has previously logged into his/her user profile during the current session), a link 1226 that is user-selectable to display the RI page to allow the travel agent user to enter any information in sections 918, 920 or 922 that may have been omitted (thereby allowing the renter to speed up the transaction when the renter arrives at the branch location to open the reservation), a link 1228 that is user-selectable to modify or cancel the confirmed reservation (it should be noted that when the travel agent client selects this link, the travel agent client is preferably disabled from altering the commission percentage selection and/or travel agent identifier that is associated with the reservation; even more preferably, the travel agent client is disabled from even viewing the commission structure in place for the reservation upon selection by the travel agent client of link 1228), a link 1230 that is user-selectable to allow the user to specify the email address of another party to whom the confirmation information will be sent, a link 1232 that is user-selectable to display a page that further educates the user about the travel agent program provided by the rental vehicle service provider or a signup page 2300 as shown in FIG. 23, and a link 1234 that is user-selectable to also return the user to page 500 that corresponds with whether the travel agent user has previously logged into his/her user profile during the current session.

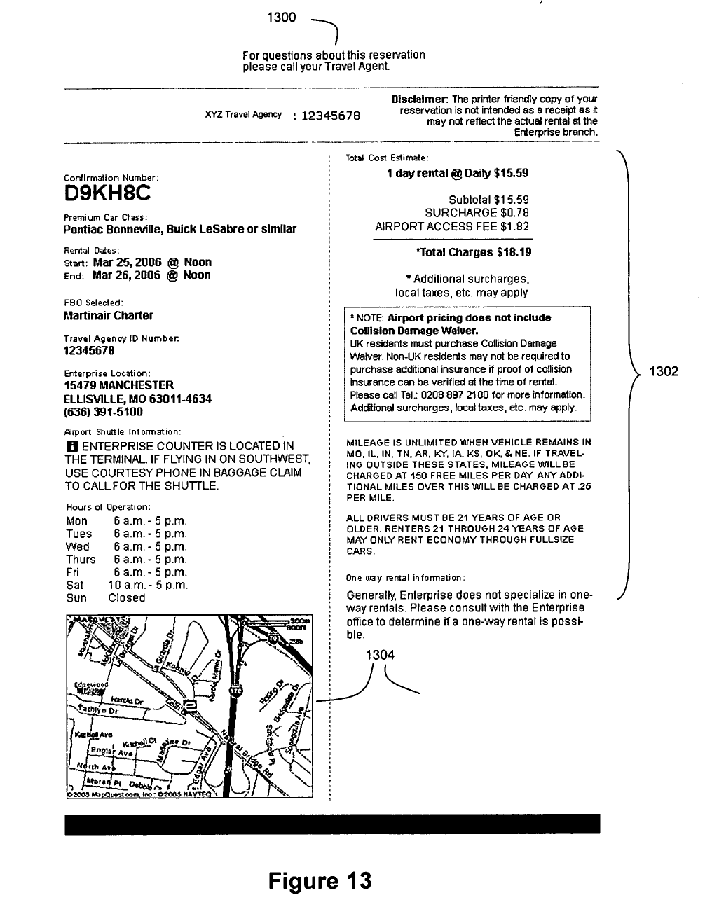

FIG. 13 illustrates an exemplary printer-friendly confirmation page 1300 that is preferably displayed and printed by the travel agent user and/or travel agent client following user selection of the “print confirmation” button on the confirmation page. Section 1302 of page 1300 summarizes the information about the reservation that is also displayed on page 1200. Section 1304 of page 1300 includes information that would be of interest to the client renter, for example a map of the area around the branch location of the rental vehicle service provider where the reservation has been booked. Preferably page 1300 would be what is displayed in an email sent to the client renter upon the booking of the reservation (or displayed in response to the selection of a link included in the email sent to the client renter). As used herein, “printer-friendly” refers to a page that has been sized and scaled by the website such that the content of the page fits within the borders of one or more conventional pages printed by a printer (such as a sheet of 8.5 inch by 11 inch paper). Typically, where possible, this means that all of the page's information is positioned within a single printout page. In instances where the page's information may not conveniently fit within a single printout page, this means that information is grouped on the different printout pages to the extent possible that minimizes a page break from breaking up commonly grouped information (such as by cutting a map in half or the like).

FIGS. 14(a)-(c) depict an exemplary page 1400 that would be displayed on the travel agent's user computer upon selection of the “my account” button 570 or upon a user signing up to create a new travel agent account (and selecting button 2308 on page 2300). Within section 1404 of page 1400, the travel agent user can enter his/her personal information such as first name, last name, telephone number, and email address. Within section 1406 of page 1400, the travel agent user can enter information about the travel agent entity with which he/she is affiliated such as travel agency name, address, and telephone number.

Within section 1408, the travel agent user can provide further personal information that can be used by the website when the travel agent user books a rental vehicle reservation for himself/herself (e.g., address, additional telephone numbers, driver's license information and even preferred reservation characteristics (not shown; as described in the above-referenced related patent applications)).

Within section 1410, the travel agent user can define the travel agent identifiers that will be associated with his/her user profile. Section 1412 will list any travel agent identifiers that are already stored in the profile. Through field 1414, the travel agent user can add a new travel agent identifier to be stored in the profile. Upon selection of link 1416, the travel agent identifier entered by the user in field 1414 will be added to the travel agent user profile.

Within section 1418, the travel agent user can define a preferred language and/or default country for reservations booked by the travel agent user through the profile.

Within section 1420, the travel agent user can control (via checkbox 1422) whether a cookie will be used to remember the travel agent user when he/she returns to the website on the same computer (thereby resulting in home page 500 of FIG. 5(b) being displayed to the user when the user enters the travel agent path at a later time from that same computer). Through section 1420, the travel agent user can also preferably change the profile's log-in information as well as cancel/delete his/her profile from database 108.

Within section 1424, the travel agent user can also preferably control the email marketing that is sent by the rental vehicle service provider to his/her email address via selectable options 1426, 1428 and 1430.

To save the information entered in page 1400, the travel agent user can select button 1432. If the travel agent user does not want to save such information, he/she can select button 1434.

Also, if the travel agent user wants to build a client list (or add to an existing client list), he/she can select link 1402. Upon selection of link 1402, page 1500 of FIG. 15 is preferably displayed.

FIG. 15 depicts an exemplary page 1500 for the travel agent user to manage his/her client list. Page 1500 is highly similar to page 1000, although page 1500 preferably includes different options in connection with each listed client.

For example, page 1500 preferably includes a link 1502 for each client listed in table 1010 that is user-selectable to initiate the booking of a new reservation for that client. Upon user selection of link 1502, the travel agent user is preferably deep-linked into the travel agent path to a page where the renter information is already pre-loaded with the client information corresponding to the selected link 1502.

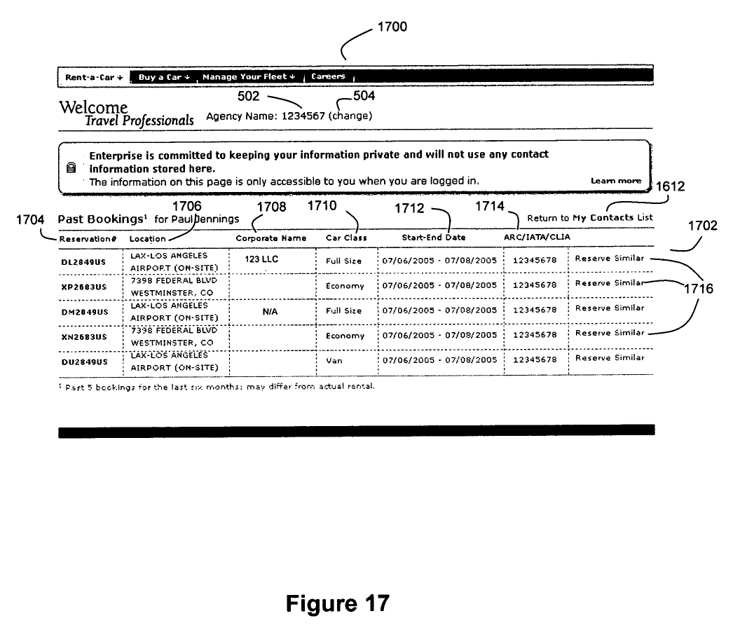

Also, page 1500 preferably includes a link 1504 for each client listed in table 1010 that is user-selectable to display page 1700 of FIG. 17. Page 1700 lists all of the past reservation bookings that the travel agent has made on behalf of the client corresponding to the selected link 1504. As shown in FIG. 17, page 1700 includes a table 1702 that lists those past bookings. Each booking in a row of the table is identified by a reservation number (column 1704), the branch location for that past reservation (column 1706), a company for that past reservation (if applicable; column 1708), the vehicle type for that past reservation (column 1710), the start/end dates for that reservation (column 1712), and the travel agent identifier(s) through which that past reservation was booked (column 1714). If the travel agent user wants to create a new reservation with all of the characteristics of a past reservation (with the exception of the past reservation's temporal information), the travel agent user can select the link 1716 corresponding to that past reservation. User selection of link 1716 will be effective to deep-link the travel agent user to a page in the travel agent path where all aspects of the reservation with the exception of the temporal information have been pre-loaded with the branch location, vehicle type, client information, and travel agent identifier(s), for the past reservation corresponding to the selected link 1716. If the travel agent user wants to return to page 1500, he/she can do so by selecting link 1612.

Returning to page 1500, table 1010 also preferably includes a link 1506 that is effective upon user-selection to delete the client information corresponding from the selected link from the database 108 for that travel agent.

To add a new client to table 1010, the travel agent user can select button 1004. User selection of button 1004 is effective to display page 1600 of FIG. 16. Page 1600 includes a section 1602 in which the travel agent user can enter client information such as first last name, email address, telephone number, company (if applicable), and any notes that the travel agent user may wish to make. Through section 1604, the travel agent user can provide additional, more detailed client information such as address, other telephone numbers, a fax number, the client's company's corporate account information (if applicable; e.g. the account number and access code therefor), and driver's license information. To add the client information entered on page 1600 to the database 108 for subsequent display in table 1010, the user can select button 1606. Upon user selection of button 1606, the user is preferably returned to page 1500. To save the client information on page 1600 and also return to a blank page 1600 for entry of information for another new client, the user can select button 1608. To clear page 1600 of any entered information without saving that information to the database, the user can select button 1610.

It should also be noted that page 1600 can optionally be reached upon user selection of button 930 from page 1900. In such a circumstance, page 1600 would be automatically populated with the client information that the travel agent user had entered on page 1900. If the user wants to then save this information to the database, he/she can do so via selection of buttons 1604 or 1606.

Thus, through the pages of FIGS. 14-17, a travel agent user is provided with powerful and flexible abilities to expedite the booking of a rental vehicle reservation on behalf of his/her client.

It should also be noted that the website and related computer systems of the rental vehicle service provider are preferably configured to prevent the use of each travel agent user's client information in their own marketing operations. However, it should be noted that in instances where a client of a travel agent user visits the website or a branch location of the rental vehicle service provider independently of the travel agent, that client may still receive marketing information from the rental vehicle service provider as a result of such a separate visit (e.g., when a travel agent client books a rental vehicle reservation for himself independently of his/her travel agent and requests that the rental vehicle service provider send him/her marketing information).

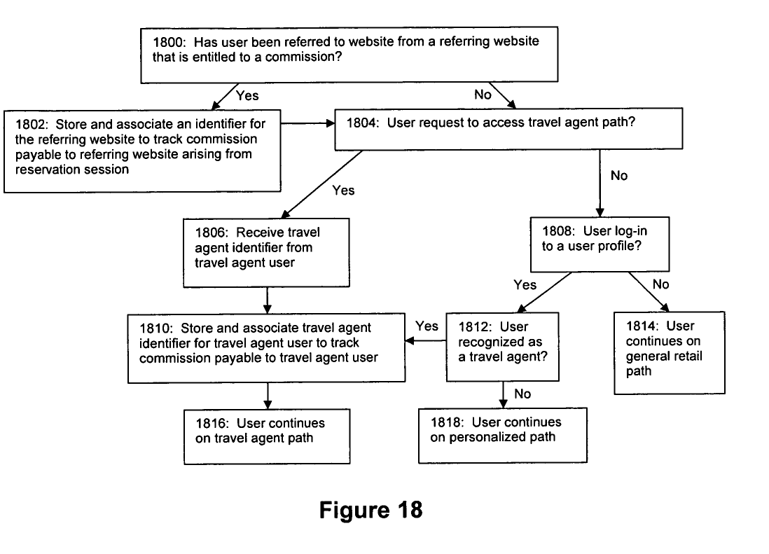

Another feature of the preferred embodiment is for the website to allow for each reservation to be associated with multiple commission tracking identifiers. FIG. 18 illustrates this process. Often times, the rental vehicle service provider will pay commissions to third party websites that refer traffic to its rental vehicle reservation-booking website. For example, search engine websites or other third party websites that include links to the rental vehicle reservation-booking website may be entitled to a commission on reservations booked by users who reach the rental vehicle reservation-booking website therefrom. In such circumstances, the third party referring website can be considered as another party that is due a commission. However, many travel agents will also access the rental vehicle reservation-booking website through a third party referring website to which a commission is payable. The embodiment of the invention described by FIG. 18 illustrates how the rental vehicle reservation-booking website can track commissions payable to both the travel agent user and the third party referring website.

Upon a request from a user to access the rental vehicle reservation-booking website, the website will check whether the user was referred to the website from a third party website to which a commission is payable in the event of a reservation being booked (step 1800). The website can learn the identity of the referring website through information that is passed in the URL when the website is accessed from the referring website (e.g., a commission tracking identifier for the referring website can be included in the URL used to access the travel agent path from the referring website). The website (or a different system) can then check a database such as database 108 to determine whether the referring website is one to which commissions are payable. If there is a referring website, and the referring website is entitled to a potential commission, then at step 1802, the website associates the retrieved identifier for the referring website with the reservation session begun by the user. This identifier serves as a commission tracking identifier and is stored by the website in association with any reservation booked through the session. The website then proceeds to step 1804.

Step 1804 can also be reached if the condition of step 1800 has not been met. If, at step 1804, the user has requested to access the travel agent path of the website (e.g., by selecting link 302 from home page 300), the website proceeds to step 1806 where a travel agent identifier is received from the user. Upon receipt of the travel agent identifier, then at step 1810, that travel agent identifier is also stored and associated with the reservation session to track any commissions that may be owed to the travel agent user. If step 1810 has been reached by way of step 1802, then it will be noted that the website has associated multiple commission tracking identifiers with a single reservation session such that commission to multiple different parties can be tracked.

It should also be noted that the commission tracking identifier for the referring website is preferably stored in association with the reservation by the website in a manner that does not allow the travel agent user to modify it. For example, through link 504 that is displayed on the travel agent path pages of the website, the travel agent user can access a page such as page 1900 of FIG. 19 to change the travel agent identifier applicable to that travel agent user. As can be seen, section 504 of page 1900 identifies the travel agent identifier currently used by the website for the travel agent user's session. Also, section 1902 of page 1900 is configured to allow the travel agent user to change the travel agent identifier of record for the travel agent user. In instances where the travel agent user has multiple travel agent identifiers stored in his/her profile (e.g., where an individual travel agent may work for multiple different travel agent entities or may have travel agent identifiers from different issuing organizations), section 1902 preferably lists these identifiers 1908 and 1912 for selection by the user via buttons 1910 and 1914. Section 1902 also preferably includes a field 1916 for user entry of a different travel agent identifier upon user selection of button 1918. Furthermore, through checkbox 1920, the travel agent user can also control whether an identifier entered in field 1916 is to be added to the user's profile in database 108. As noted, page 1900 preferably does not give the travel agent user the ability to change the identifier used for any referring website's commission tracking.

Returning to FIG. 18, following step 1810, the website proceeds to step 1816 where the travel agent user continues along the travel agent path of the website.

If step 1804 results in a determination that the user did not request to access the travel agent path, then at step 1808, the website preferably checks whether the user has requested to access his/her stored profile (e.g., through button 304 of page 300). If the user has not, then the website proceeds to step 1814 where the user continues along the general retail path of the website. If the user has accessed his/her profile by logging in, then at step 1812, the website checks whether the user's profile identifies the user as a travel agent. If the user's profile indicates the user is a travel agent, then the website proceeds to step 1810. If the user's profile indicates that the user is not a travel agent, then the website proceeds to step 1818 where the user continues along a personalized path of the website.

It should be noted that the commissions paid to travel agents and referring websites can be achieved in any of a number of ways. For example, the price from which the referring website's commission is calculated can optionally exclude any increases in price for the reservation that are caused by the commission payable to the travel agent (particularly in cases where the travel agent user has specified a larger than normal commission percentage for the reservation through section 514 of page 500).

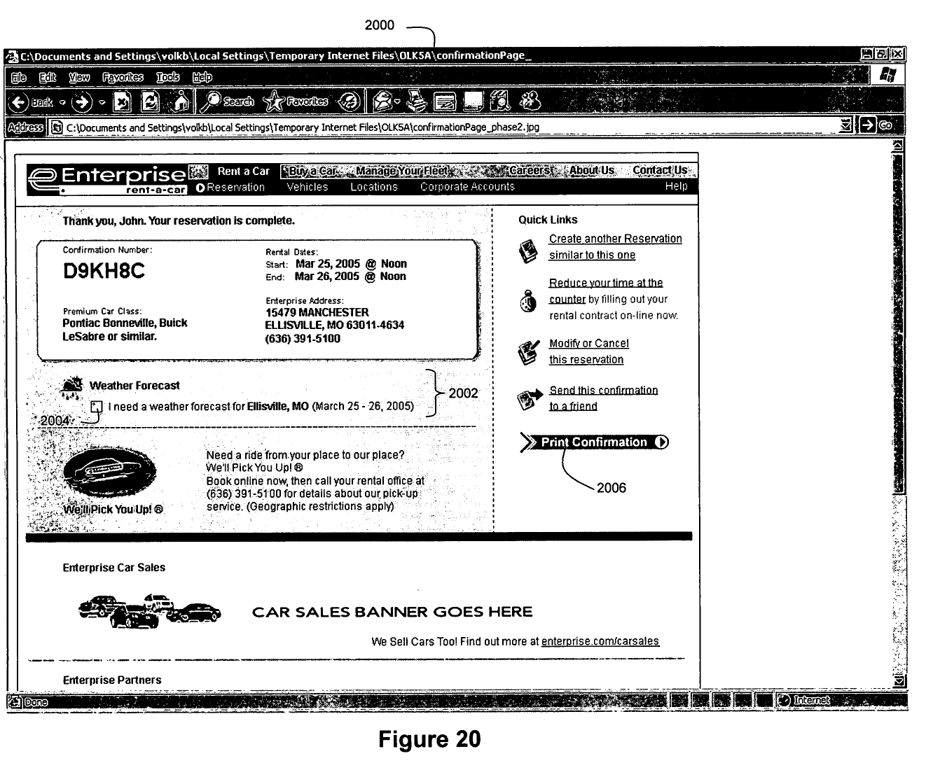

Another feature of the preferred embodiment is for the website to provide confirmation pages that are user configurable, to either or both of the wishes of the travel agent user and the travel agent client. FIG. 20 depicts an exemplary user-configurable confirmation page 2000. Confirmation page 2000 preferably includes the same or similar confirmation information as that included on page 1200 of FIG. 12. However, page 2000 also includes a user-configurable feature section 2002. The feature that is user-configurable on the confirmation page is preferably a feature that would be of interest to the travel agent client/renter and/or the travel agent user. In the example of FIG. 20, the user-configurable feature is a weather report. Thus, through section 2002, the travel agent user and/or travel agent client can choose whether the confirmation page will include a weather report for the area near the branch location selected for the rental vehicle reservation during the time period selected for the reservation (e.g., via checkbox 2004) If the start date for the reservation is too far into the future for a weather report to be available, then the user can be so notified. If checkbox 2004 is selected, followed by selection of button 2006, a printer-friendly confirmation page is preferably displayed that includes a weather report for the area near the reservation's branch location. To obtain such a weather report, the website can access any of numerous commercially available weather forecasting websites to retrieve the appropriate weather report information. The resulting printer-friendly confirmation page preferably includes the requested weather report in section 1304 (see FIG. 13). It should also be noted that the report can be presented in section 1304 in any of a number of formats (e.g., daily, hourly (or other intervals) temperature and precipitation forecasts, radar maps, and the like).

It should also be noted that the user-configurable confirmation page 2000 is preferably viewed by both the travel agent user and the travel agent client (when a link to the page 2000 is emailed to the travel agent client following the reservation's booking by the travel agent user). Thus, the user-configurable confirmation page, as well as the resulting printer-friendly confirmation page, can preferably be accessed by both the travel agent user and the travel agent client.

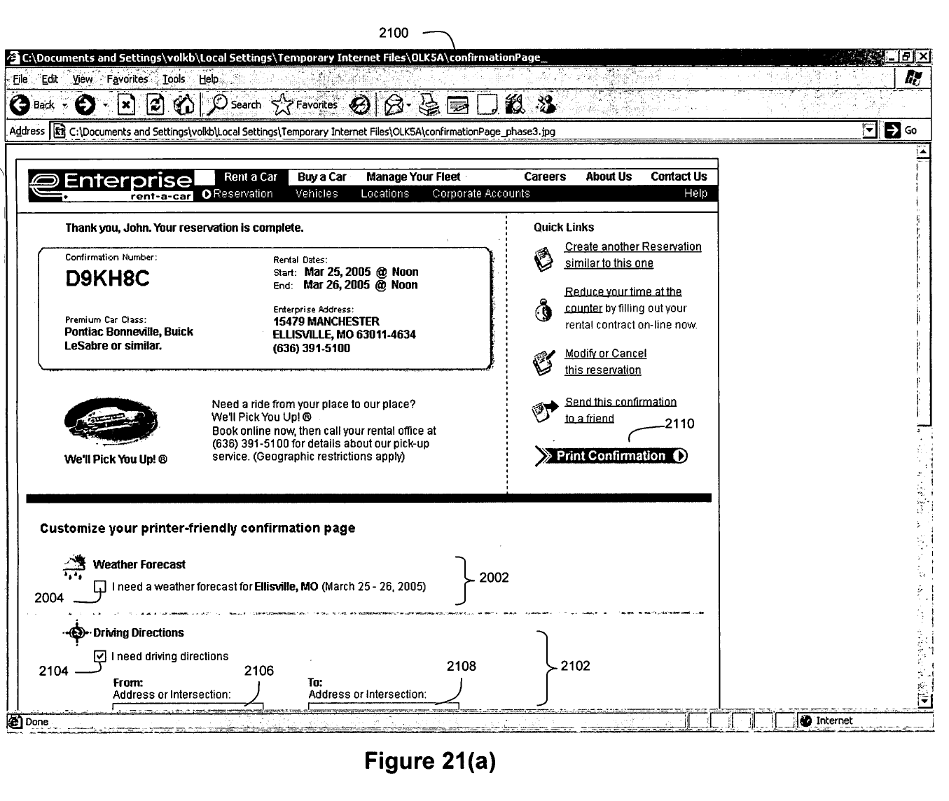

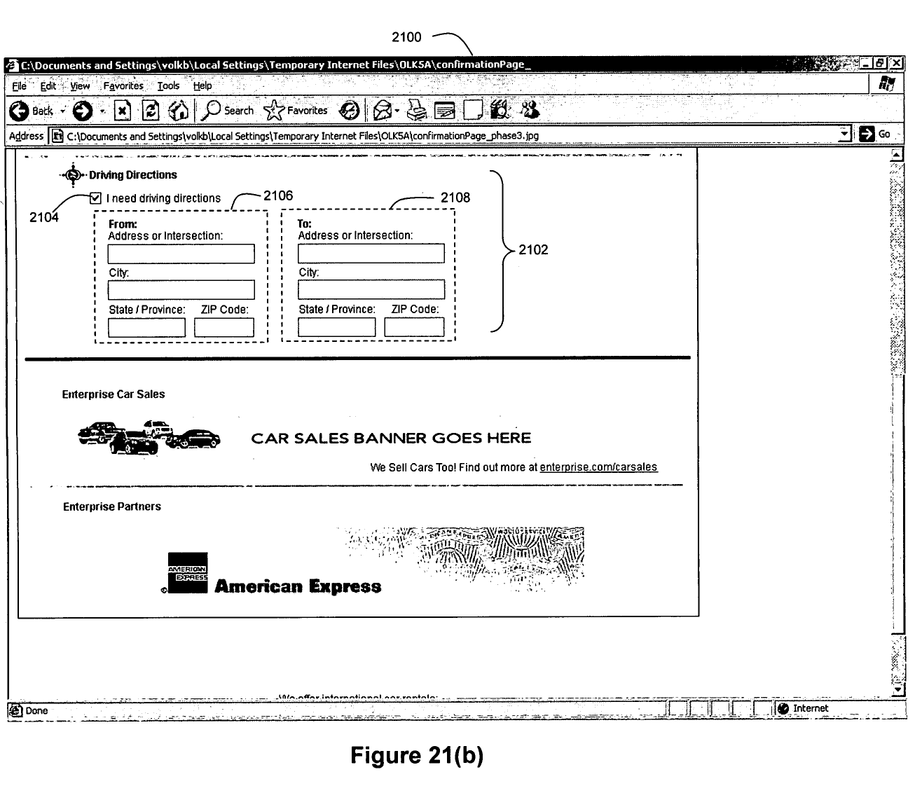

FIGS. 21(a) and (b) depict an additional example of a user-configurable confirmation page 2100, wherein an additional feature is user-configurable. In the example of page 2100, an additional feature of driving directions is also added to the user-configurable nature of the confirmation page. Of course, it should be noted that alternatively, page 2100 could include the user-configurable driving directions feature but not the user-configurable weather report feature. Section 2102 of page 2100 includes the user-configurable driving directions feature. With this feature, a travel agent user and/or travel agent client can specify (e.g., via checkbox 2104) whether the printer-friendly confirmation page will include driving directions in section 1304 of page 1300. For example, the driving directions can be directions from a user-specified origin 2106 to a user-specified destination 2108. Similarly, the driving directions can be from a fixed location such as the selected branch location for the reservation to a user-specified destination or vice versa. The resulting display in section 1304 that is displayed upon selection of button 2110 can be a map and/or textual instructions that describe the navigational route in accordance with the origin and destination of the directions. To obtain such a map and/or textual instructions, the website can access any of numerous commercially available mapping/driving direction websites to retrieve the appropriate information.

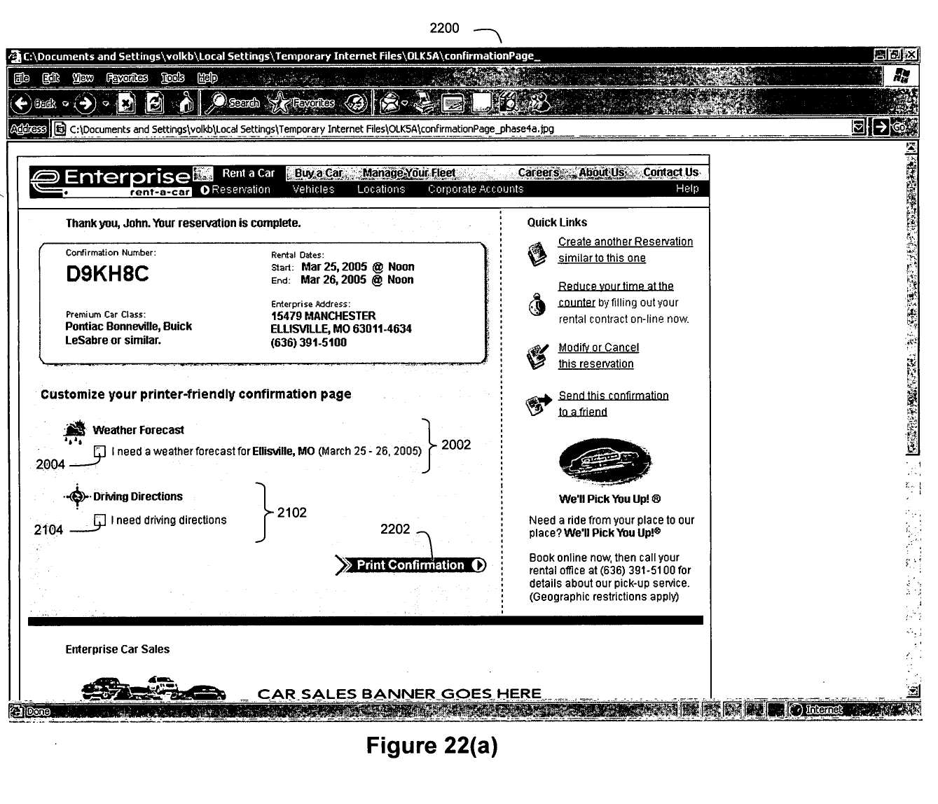

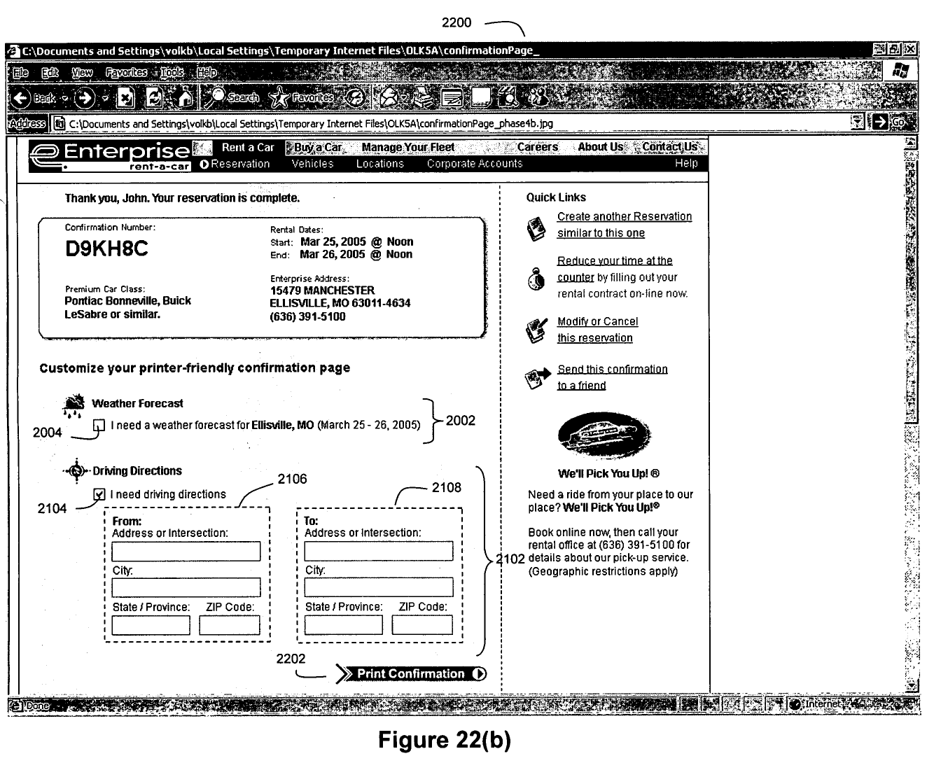

FIGS. 22(a) and (b) illustrate a page 2200 that is an alternate version page 2100. With page 2200, section 2102 includes only checkbox 2104 when checkbox 2104 is in an unselected state. Upon user-selection of checkbox 2104, then section 2102 is expanded to include sections 2106 and 2108 for user entry of origin and destination information. User selection of button 2202 is effective to display a printer-friendly confirmation page wherein section 1304 includes a weather report and/or driving directions as directed by the user.

Optionally, the travel agent user's and/or the travel agent client's stored profile may be configured to specify whether and what type of features are to be displayed in section 1304 of the printer-friendly confirmation page. For example, the user's stored profile may include a setting that instructs the website to always display a weather report for the area near the branch location selected for the reservation during the reservation's time period.

Additional examples of user-configurable display features can include a confirmation page that displays a promotional offer or an available rental coupon in response to user input. Similarly, user input can be used to define whether the confirmation page will include advertisements and/or coupons for various attractions, stores, restaurants, or the like in the area where the branch location for the reservation is located. In this manner, if the user wishes to be informed of such options in the area, he/she can request that such information be included on the confirmation page. When printed out, the confirmation page can then serve as a useful reference for a renter who is visiting an unfamiliar area. To provide such information, the website can maintain a database of information eligible for inclusion on confirmation pages in response to user input.

It should also be noted that the travel agent user may want to include some form of note to his/her client in the confirmation page that is communicated to the client. To do so, the travel agent's stored profile may include one or more text strings that will automatically be included in the confirmation page, for example in a section above the confirmation information on the confirmation or printer-friendly confirmation page or in another available section on the page. The travel agent user's profile management page, such as the one shown in FIG. 14, can be configured to allow the travel agent user to define what text strings will be included in the client's confirmation and/or printer-friendly confirmation page. Additionally or alternatively, a text entry field could be included in the verify page 1100 through which the travel agent user can specify the text to be included in the client's confirmation and/or printer-friendly confirmation page. It is believed by the inventors herein that travel agent users would be desirous of such a feature because it allows the travel agent to effectively communicate to the client that it was through his/her efforts that the rental vehicle reservation was booked.

While the present invention has been described above in relation to its preferred embodiment, various modifications may be made thereto that still fall within the invention's scope, as would be recognized by those of ordinary skill in the art. Such modifications to the invention will be recognizable upon review of the teachings herein. For example, while the destination and port menus of FIG. 6(a) and (b) have been described in connection with the travel agent path, it should be noted that the functionality provided by these menus as well as the ability to access these menus from a home page can also be utilized for a general retail customer path of the website or any other paths beyond just the travel agent path. Similarly, the user-configurable confirmation pages could also be advantageously implemented for all customers, and not just travel agent users. As such, the full scope of the present invention is to be defined solely by the appended claims and their legal equivalents.

What is claimed is:

1. A method for providing rental vehicle reservation booking services through an Internet website, the website being accessible by a user computer over the Internet and comprising a plurality of pages for display on the user computer, the method comprising:
providing a travel agent path through the website for access by a user, wherein at least one of the pages of the travel agent path is configured to accept user input that defines a commission to be owed to a travel agent for a rental vehicle reservation booked by that user.

2. The method of claim 1 wherein the travel agent path providing step comprises:
displaying a page on the user computer, the page being configured to display a plurality of selectable options for commission percentages to be applied to a rental vehicle reservation booked by that user.

3. The method of claim 1 further comprising:
receiving input from the user that defines the commission for the rental vehicle reservation; and
adjusting a price for the rental vehicle reservation in response to the defined commission for that rental vehicle reservation.

4. A system for providing rental vehicle reservation creation services, the system comprising:
a memory in which data for a rental vehicle reservation is stored; and
a server in communication with the memory and the Internet, wherein the server is configured to provide an Internet website for access over the Internet by a user computer to book a rental vehicle reservation, the website comprising a plurality of pages for display on the user computer, wherein a plurality of the pages are user-interactive to accept user input regarding a creation of a rental vehicle reservation with a rental vehicle service provider;
wherein the server is configured to provide a travel agent path through the website for access by a user, wherein at least one of the website pages of the travel agent path is configured to accept user input that defines a commission to be owed to a travel agent for a rental vehicle reservation booked by that user.

5. The system of claim 4 wherein the server is further configured to provide a page within the travel agent path for display on the user computer, the page being configured to display a plurality of selectable options for commission percentages to be applied to a rental vehicle reservation booked by that user.

6. The system of claim 4 wherein the server is further configured to (1) receive input from the user that defines the commission for the rental vehicle reservation, and (2) adjust a price for the rental vehicle reservation in response to the defined commission for that rental vehicle reservation.

7. A system for providing rental vehicle reservation creation services, the system comprising:
a memory in which data for a rental vehicle reservation is stored; and
a server in communication with the memory and the Internet, wherein the server is configured to provide an Internet website for access over the Internet by a user computer to book a rental vehicle reservation, the website comprising a plurality of pages for display on the user computer, wherein a plurality of the pages are user-interactive to accept user input regarding a creation of a rental vehicle reservation with a rental vehicle service provider;
wherein the server is configured to (1) provide a travel agent path through the website for access by a user, and (2) within the travel agent path, accept input from the user on a per rental vehicle reservation basis that defines a commission to be owed to a travel agent for each rental vehicle reservation booked for that travel agent.

8. A method for providing rental vehicle reservation booking services through an Internet website, the website being accessible by a user computer over the Internet and comprising a plurality of pages for display on the user computer, the method comprising:
providing a travel agent path through the website for access by a user;
storing a client list for the travel agent; and
providing at least one page of the travel agent path that is configured to accept input from the user selecting a client from the stored client list as a renter for a rental vehicle reservation booked by that user.

9. The method of claim 8 further comprising:
displaying the client list as a menu of selectable options on the provided at least one page.

10. The method of claim 8 further comprising:
storing a plurality of types of client information for a plurality of the clients on the client list; and
in response to user input selecting a client from the stored client list as a renter for a rental vehicle reservation booked by that user, automatically loading the rental vehicle reservation with the client information stored for the selected client.

11. The method of claim 10 wherein the automatically loading step comprises automatically loading a renter information page of the travel agent path with the client information stored for the selected client.

12. A system for providing rental vehicle reservation creation services, the system comprising:
a memory in which a client list for a travel agent is stored;
a server in communication with the memory and the Internet, wherein the server is configured to provide an Internet website for access over the Internet by a user computer to book a rental vehicle reservation, the website comprising a plurality of pages for display on the user computer, wherein a plurality of the pages are user-interactive to accept user input regarding a creation of a rental vehicle reservation with a rental vehicle service provider; and
wherein the server is configured to provide a travel agent path through the website for access by a user of the user computer, wherein at least one of the website pages of the travel agent path is configured to accept input from the user selecting a client from the stored client list as a renter for a rental vehicle reservation booked by that user.

13. The system of claim 12 wherein the at least one website page is configured to display the client list as a menu of selectable options.

14. The system of claim 12 wherein the memory is further configured to store a plurality of types of client information for a plurality of the clients on the client list; and
wherein the server is further configured to, in response to a received user input that selects a client from the stored client list as a renter for a rental vehicle reservation booked by that user, automatically load the rental vehicle reservation with the client information stored in memory for the selected client.

15. The system of claim 14 wherein the server is further configured to automatically load a renter information page of the travel agent path with the client information stored in memory for the selected client in response to the received user input.

16. A method for providing rental vehicle reservation booking services through an Internet website, the website being accessible by a user computer over the Internet and comprising a plurality of pages for display on the user computer, the method comprising:
providing a travel agent path through the website for access by a user;
maintaining a profile for the travel agent;
storing a client list for the travel agent in the travel agent profile, the client list for access from at least one page of the travel agent path by the user when booking a rental vehicle reservation on behalf of a client.

17. The method of claim 16 further comprising:
adding a client to the stored client list in response to input from the user on at least one page of the travel agent path.

18. The method of claim 17 further comprising:
automatically adding a client to the stored client list when the user books a rental vehicle reservation for a client who was not previously stored on the client list in that travel agent's profile.

19. The method of claim 17 further comprising:
storing a plurality of types of client information for a plurality of the clients on the client list in response to input from the user.

20. The method of claim 16 further comprising:
maintaining a past reservation history for a plurality of clients on the client list;
receiving input from a user corresponding to a selection of a client from the client list; and
on at least one page that is accessible to the user within the travel agent path, displaying the past reservation history for the selected client.

21. The method of claim 20 further comprising:
displaying a plurality of the past rental vehicle reservations for the selected client on the at least one page that is accessible to the user within the travel agent path; and
providing a selectable option for each listed past rental vehicle reservation that is effective upon selection by the user to begin a new rental vehicle reservation having at least one characteristic in common with the selected past rental vehicle reservation.

22. A system for providing rental vehicle reservation creation services, the system comprising:
a memory in which a profile for a travel agent user is stored; and
a server in communication with the memory and the Internet, wherein the server is configured to provide an Internet website for access over the Internet by a user computer to book a rental vehicle reservation, the website comprising a plurality of pages for display on the user computer, wherein a plurality of the pages are user-interactive to accept user input regarding a creation of a rental vehicle reservation with a rental vehicle service provider; and
wherein the server is configured to provide a travel agent path through the website for access by the user; and
wherein the travel agent profile is configured to store a client list for the travel agent, the client list for access from at least one page of the travel agent path by the user when booking a rental vehicle reservation on behalf of a client.

23. The system of claim 22 wherein the server is further configured to add a client to the stored client list in response to input from the user on at least one page of the travel agent path.

24. The system of claim 23 wherein the server is further configured to automatically add a client to the stored client list responsive to a determination by the server that the user has booked a rental vehicle reservation for a client who was not previously stored on the client list in that travel agent's profile.

25. The system of claim 23 wherein the memory is further configured to store a plurality of types of client information for a plurality of the clients on the client list in response to input from the user.

26. The system of claim 22 wherein the memory is further configured to store a past reservation history for a plurality of clients on the client list, wherein the server is further configured to (1) receive input from a user corresponding to a selection of a client from the client list, and (2) on at least one page that is accessible to the user within the travel agent path, display the past reservation history for the selected client.

27. The system of claim 26 wherein the at least one page that is accessible to the user within the travel agent path, is configured to (1) display a plurality of the past rental vehicle reservations for the selected client on the at least one page that is accessible to the user within the travel agent path, and (2) provide a selectable option for each listed past rental vehicle reservation that is effective upon selection by the user to begin a new rental vehicle reservation having at least one characteristic in common with the selected past rental vehicle reservation.

28. A method for providing rental vehicle reservation booking services through an Internet website, the website being accessible by a user computer over the Internet and comprising a plurality of pages for display on the user computer, the method comprising:
providing a travel agent path through the website for access by a user;
maintaining a profile for the travel agent;
storing a plurality of travel agent identifiers in the travel agent profile, each travel agent identifier being selectable by the user for association with a rental vehicle reservation booked by the user to track a commission for the travel agent.

29. A system for providing rental vehicle reservation creation services, the system comprising:
a memory in which a profile for a travel agent user is stored;
a server in communication with the memory and the Internet, wherein the server is configured to provide an Internet website for access over the Internet by a user computer to book a rental vehicle reservation, the website comprising a plurality of pages for display on the user computer, wherein a plurality of the pages are user-interactive to accept user input regarding a creation of a rental vehicle reservation with a rental vehicle service provider; and
wherein the server is configured to provide a travel agent path through the website for access by the user; and
wherein the travel agent profile is configured to store a plurality of travel agent identifiers, each travel agent identifier being selectable by the user for association with a rental vehicle reservation booked by the user to track a commission for the travel agent.

30. A method for providing rental vehicle reservation booking services through an Internet website, the website being accessible by a user computer over the Internet and comprising a plurality of pages for display on the user computer, the method comprising:
associating a plurality of commission tracking identifiers with a single rental vehicle reservation that is booked through a travel agent path of the website such that a plurality of commissions are payable to a plurality of parties for the single rental vehicle reservation.

31. The method of claim 30 further comprising:
providing the travel agent path through the website for access by a user, the user having an associated travel agent identifier; and
receiving a referral of the user to the website from a third party referring website, the referring website having an associated identifier; and
wherein the plurality of commission tracking identifiers comprise the travel agent identifier and the referring website identifier.

32. The method of claim 31 wherein at least one page of the travel agent path is configured to accept input from the user to change the travel agent identifier for the single rental vehicle reservation, and wherein the pages of the travel agent path are not configured to allow the user to change the referring website identifier for the single rental vehicle reservation.

33. A system for providing rental vehicle reservation creation services, the system comprising:
a memory in which data for a rental vehicle reservation is stored; and
a server in communication with the memory and the Internet, wherein the server is configured to provide an Internet website for access over the Internet by a user computer to book a rental vehicle reservation, the website comprising a plurality of pages for display on the user computer, wherein a plurality of the pages are user-interactive to accept user input regarding a creation of a rental vehicle reservation with a rental vehicle service provider;
wherein the server is configured to associate a plurality of commission tracking identifiers with a single rental vehicle reservation that is booked through a travel agent path of the website such that a plurality of commissions are payable to a plurality of parties for the single rental vehicle reservation.

34. The system of claim 33 wherein the server is further configured to (1) provide the travel agent path through the website for access by a user, the user having an associated travel agent identifier, and (2) receive a referral of the user to the website from a third party referring website, the referring website having an associated identifier, and wherein the plurality of commission tracking identifiers comprise the travel agent identifier and the referring website identifier.

35. The system of claim 34 wherein at least one page of the travel agent path is configured to accept input from the user to change the travel agent identifier for the single rental vehicle reservation, and wherein the pages of the travel agent path are not configured to allow the user to change the referring website identifier for the single rental vehicle reservation.

36. A method for providing rental vehicle reservation booking services through an Internet website, the website being accessible by a user computer over the Internet and comprising a plurality of pages for display on the user computer, the method comprising:
providing a confirmation page for display on the user computer, the confirmation page including a user-configurable display feature.

37. The method of claim 36 wherein the confirmation page further includes a display of confirmation information for a rental vehicle reservation that has been booked at a branch location of a rental vehicle service provider during a reservation time period, and wherein the user-configurable display feature comprises a weather report for an area in which the branch location is located and during the reservation time period.

38. The method of claim 36 wherein the user-configurable display feature comprises driving directions from an origin to a destination.

39. The method of claim 38 wherein the origin comprises a user-specified origin.

40. The method of claim 39 wherein the destination comprises a user-specified destination.

41. The method of claim 38 wherein the destination comprises a user-specified destination.

42. The method of claim 36 further comprising:
receiving input from the user computer corresponding to a selection by a user of the user computer of the display feature that is to be included in the confirmation page; and
responsive to the received input, including the selected display feature in the confirmation page.

43. The method of claim 42 wherein the confirmation page comprises a printer-friendly confirmation page.

44. The method of claim 36 wherein the confirmation page further includes a display of confirmation information for a rental vehicle reservation that has been booked by a user on behalf of a travel agent client through a travel agent path of the website, the method further comprising:
configuring the display feature of the confirmation page in response to input from the user via the travel agent path.

45. The method of claim 36 wherein the confirmation page further includes a display of confirmation information for a rental vehicle reservation that has been booked by a user on behalf of a travel agent client, the method further comprising:
configuring the display feature of the confirmation page in response to input from the travel agent client.

46. The method of claim 36 wherein the confirmation page further includes a display of confirmation information for a rental vehicle reservation that has been booked by a user on behalf of a travel agent client through a travel agent path of the website, the method further comprising:
maintaining a profile that is associated with the travel agent client;
in response to input by the user, storing in the profile the display feature to be included in the confirmation page; and
configuring the display feature of the confirmation page in accordance with the profile associated with the travel agent client.

47. The method of claim 36 wherein the confirmation page further includes a display of confirmation information for a rental vehicle reservation that has been booked by a user on behalf of a travel agent client via a travel agent path of the website, the method further comprising:
maintaining a profile that is associated with the travel agent client;
in response to input by the travel agent client, storing in the profile the display feature to be included in the confirmation page; and
configuring the display feature of the confirmation page in accordance with the profile associated with the travel agent client.

48. A system for providing rental vehicle reservation creation services, the system comprising:
a memory in which data for a rental vehicle reservation is stored; and
a server in communication with the memory and the Internet, wherein the server is configured to provide an Internet website for access over the Internet by a user computer to book a rental vehicle reservation, the website comprising a plurality of pages for display on the user computer, wherein a plurality of the pages are user-interactive to accept user input regarding a creation of a rental vehicle reservation with a rental vehicle service provider; and
wherein at least one of the pages comprises a confirmation page, the confirmation page including a user-configurable display feature.

49. The system of claim 48 wherein the confirmation page further includes a display of confirmation information for a rental vehicle reservation that has been booked at a branch location of a rental vehicle service provider during a reservation time period, and wherein the user-configurable display feature comprises a weather report for an area in which the branch location is located and during the reservation time period.

50. The system of claim 48 wherein the user-configurable display feature comprises driving directions from an origin to a destination.

51. The system of claim 50 wherein the origin comprises a user-specified origin.

52. The system of claim 51 wherein the destination comprises a user-specified destination.

53. The system of claim 50 wherein the destination comprises a user-specified destination.

54. The system of claim 48 wherein the server is further configured to (1) provide at least one page on the user computer that is configured to accept input from the user computer corresponding to a selection by a user of the user computer of the display feature that is to be included in the confirmation page, and (2) in response to input from the user computer corresponding to a selection by a user of the user computer of the display feature that is to be included in the confirmation page, include the selected display feature in the confirmation page.

55. The system of claim 54 wherein the confirmation page comprises a printer-friendly confirmation page.

56. The system of claim 48 wherein the confirmation page further includes a display of confirmation information for a rental vehicle reservation that has been booked by a user on behalf of a travel agent client through a travel agent path of the website, and wherein the server is further configured to configure the display feature of the confirmation page in response to input from the user via the travel agent path.

57. The system of claim 48 wherein the confirmation page further includes a display of confirmation information for a rental vehicle reservation that has been booked by a user on behalf of a travel agent client through a travel agent path of the website, and wherein the server is further configured to configure the display feature of the confirmation page in response to input from the travel agent client.

58. The system of claim 48 wherein the confirmation page further includes a display of confirmation information for a rental vehicle reservation that has been booked by a user on behalf of a travel agent client through a travel agent path of the website, and wherein the server is further configured to (1) maintain a profile that is associated with the travel agent client, (2) in response to input by the user, store in the profile the display feature to be included in the confirmation page, and (3) configure the display feature of the confirmation page in accordance with the profile associated with the travel agent client.

59. The system of claim 48 wherein the confirmation page further includes a display of confirmation information for a rental vehicle reservation that has been booked by a user on behalf of a travel agent client through a travel agent path of the website, and wherein the server is further configured to (1) maintain a profile that is associated with the travel agent client, (2) in response to input by the travel agent client, store in the profile the display feature to be included in the confirmation page, and (3) configure the display feature of the confirmation page in accordance with the profile associated with the travel agent client.

60. A method for providing rental vehicle reservation booking services through an Internet website, the website being accessible by a user computer over the Internet and comprising a plurality of pages for display on the user computer, the method comprising:
providing a travel agent path through the website for access by a user to book a rental vehicle reservation on behalf of a client;
receiving from the user an email address of the client; and
responsive to the user booking the rental vehicle reservation for the client through the travel agent path, sending an email from a server for the website to the client's email address that summarizes the rental vehicle reservation booked by the user.

61. A system for providing rental vehicle reservation creation services, the system comprising:
a memory in which data for a client of a travel agent is stored, the data including an email address of the client; and
a server in communication with the memory and the Internet, wherein the server is configured to provide an Internet website for access over the Internet by a user computer to book a rental vehicle reservation, the website comprising a plurality of pages for display on the user computer, wherein a plurality of the pages are user-interactive to accept user input regarding a creation of a rental vehicle reservation with a rental vehicle service provider;
wherein the server is configured to (1) provide a travel agent path through the website for access by a user to book a rental vehicle reservation on behalf of the client, and (2) send an email from a server to the client's stored email address that summarizes the rental vehicle reservation booked by the user on behalf of the client.

62. A method for providing rental vehicle reservation booking services through an Internet website, the website being accessible by a user computer over the Internet and comprising a plurality of pages for display on the user computer, the method comprising:
associating each of a plurality of travel destinations with at least one branch location of a rental vehicle service provider;
providing a page of the website for access by the user computer that lists at least a plurality of the travel destinations for selection by a user of the user computer;
receiving from the user a selection of one of the listed destinations; and
determining a branch location eligible for a rental vehicle reservation to be booked by the user based at least in part upon which at least one branch location is associated with the selected destination.

63. The method of claim 62 further comprising:
determining whether a single branch location is associated with the selected destination;
in response to a determination that only a single branch location is associated with the selected destination, automatically setting that branch location as the branch location for the reservation; and
in response to a determination that a plurality of branch locations are associated with the selected destination, displaying a page on the user computer that lists the plurality of branch locations that are associated with the selected destination.

64. The method of claim 63 wherein the plurality of destinations comprise a plurality of ports of call.

65. A system for providing rental vehicle reservation creation services, the system comprising:
a memory in which data for a rental vehicle reservation is stored, the data including a plurality of associations between a plurality of branch locations of a rental vehicle service provider and a plurality of travel destinations; and
a server in communication with the memory and the Internet, wherein the server is configured to provide an Internet website for access over the Internet by a user computer to book a rental vehicle reservation, the website comprising a plurality of pages for display on the user computer, wherein a plurality of the pages are user-interactive to accept user input regarding a creation of a rental vehicle reservation with the rental vehicle service provider;
wherein the server is further configured to (1) provide at least one page of the website for display on the user computer that lists a plurality of the travel destinations for selection by the user, the at least one page being configured to accept user input corresponding to a selection of one of the listed destinations, and (2) determine at least one branch location eligible for the rental vehicle reservation based at least in part upon the associations between branch locations and travel destinations stored in the memory.

66. The system of claim 65 wherein the server is further configured to (1) determine from the associations stored in memory whether a single branch location is associated with the selected destination, (2) in response to a determination that only a single branch location is associated with the selected destination, automatically set that branch location as the branch location for the reservation, and (3) in response to a determination that a plurality of branch locations are associated with the selected destination, display a page on the user computer that lists the plurality of branch locations that are associated with the selected destination.

67. The system of claim 66 wherein the plurality of destinations comprise a plurality of ports of call.
